(19) United States
(12) Patent Application Publication
(10) Pub. No.: US 2026/0252817 A1
(43) Pub. Date: Aug. 27, 2026

(54) SYSTEM

(71) Applicant: SoftBank Group Corp., Tokyo (JP)

(72) Inventor: Shogo SUZUKI, Tokyo (JP)

(73) Assignee: SoftBank Group Corp., Tokyo (JP)

(21) Appl. No.: 19/531,730

(22) Filed: Feb. 6, 2026

(30) Foreign Application Priority Data
Feb. 21, 2025 (JP) 2025-027053

(51) Int. Cl. G06F 40/40; G06F 40/284; G06K 7/10; G06K 7/14; H04L 49/35

(52) U.S. Cl. CPC G06F 40/40; G06F 40/284; G06K 7/10297; G06K 7/1413; G06K 7/1417; H04L 49/355

(57) ABSTRACT

The system according to the embodiment comprises a collection unit, a generation unit, a reading unit, a response generation unit, and a provision unit. The collection unit collects information regarding objects. The generation unit generates a prompt based on the information collected by the collection unit. The reading unit reads an information tag including the prompt generated by the generation unit. The response generation unit analyzes the prompt read by the reading unit and generates a response. The provision unit provides the response generated by the response generation unit to a user.

### CROSS-REFERENCE TO RELATED APPLICATION

The present application claims priority to and incorporates by reference the entire contents of Japanese Patent Application No. 2025-027053 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, means for efficiently collecting information regarding objects and providing it to users are limited, and there is room for improvement.

### SUMMARY OF THE INVENTION

The system according to the embodiment comprises a collection unit, a generation unit, a reading unit, a response generation unit, and a provision unit. The collection unit collects information regarding objects. The generation unit generates a prompt based on the information collected by the collection unit. The reading unit reads an information tag including the prompt generated by the generation unit. The response generation unit analyzes the prompt read by the reading unit and generates a response. The provision unit provides the response generated by the response generation unit to a user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

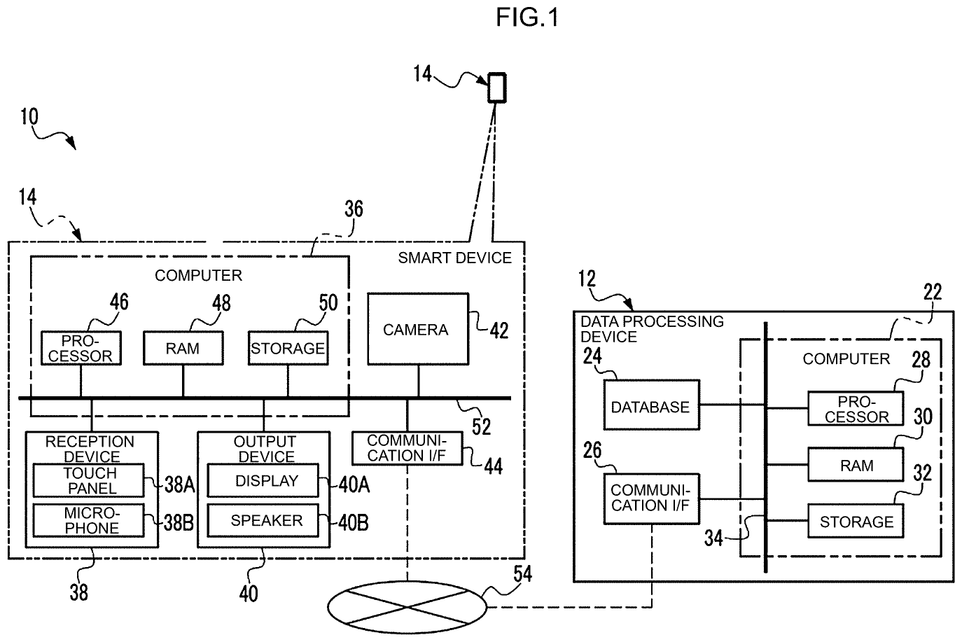

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

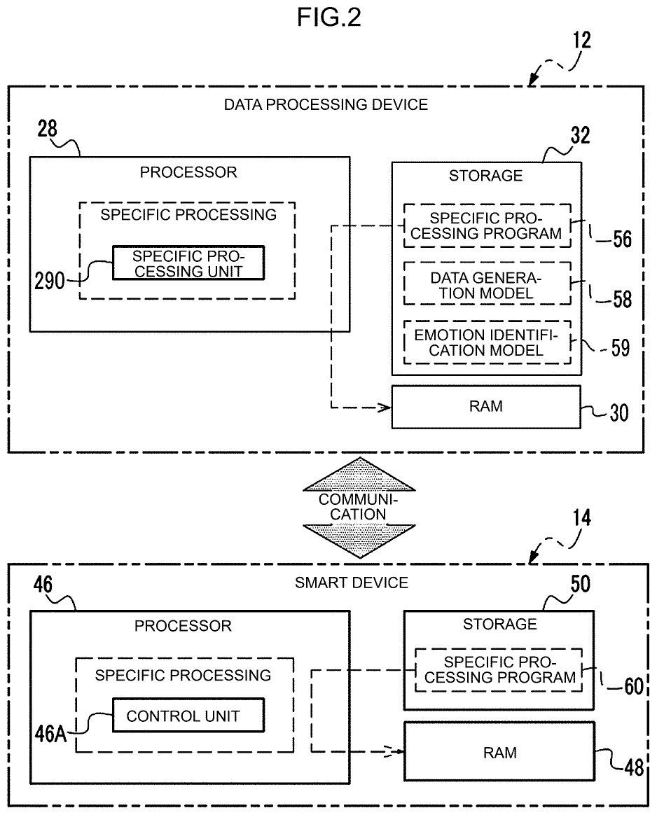

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that enables communication with objects by attaching information tags (for example, QR codes) to various objects in the surroundings. In this system, information tags are first attached to each object. Next, the user reads the information tag using a device such as a smartphone. The read information tag includes a prompt that has been input in advance, and a generative AI generates a response for communicating with the object based on the prompt. For example, when an information tag attached to a home appliance is read, the generative AI provides an explanation of the functions of the home appliance. In addition, when an information tag attached to a map bulletin board is read, the generative AI provides route guidance. With this mechanism, the user can easily obtain information about the object. For example, information tags can be attached to various objects such as home appliances, furniture, map bulletin boards, and public facilities. Next, the user reads the information tag using a device such as a smartphone. The read information tag includes a prompt that has been input in advance, and the generative AI generates a response based on the prompt. For example, when an information tag attached to a home appliance is read, a prompt such as “Tell me how to use this home appliance” is input to the generative AI, and the generative AI generates a response explaining how to use the home appliance. In addition, when an information tag attached to a map bulletin board is read, a prompt such as “How do I get from XX to XX?” is input to the generative AI, and the generative AI generates a response providing route guidance. In this way, the user can easily obtain information about the object. Furthermore, the generative AI can also generate responses to the user's questions. For example, if the user asks “Tell me about a specific function of this home appliance,” the generative AI generates a response to that question. With this mechanism, the user can obtain detailed information about the object. Thus, by attaching information tags to various objects in the surroundings, the user can communicate with the object and easily obtain information about the object. As a result, the user can easily obtain information about objects to which information tags have been attached. Specifically, the present system includes a series of technical processing flows: attaching information tags, reading tag information, extracting prompts, inputting to generative AI, generating responses, and presenting responses. The system uses two-dimensional codes such as QR codes and NFC tags or wireless tags as information tags, and encodes object-specific IDs and prompt information in the tags. The user terminal (e.g., smartphone) reads the tag using a camera or NFC reader, and inputs the prompt extracted from the tag (e.g., natural language text such as “Tell me how to use this home appliance”) to the generative AI. As the generative AI, a large-scale language model (LLM) with billions of parameters or a multimodal generative model that integrally handles images, audio, and text can be used. Examples of input to the AI include: (1) “Tell me how to use the defrost function of this microwave oven,” (2) “Guide me from this map bulletin board to the station by the shortest route,” (3) “Explain the assembly procedure for this furniture.” The AI tokenizes the input prompt, converts it into an embedding vector (e.g., a floating-point vector of length 2048), and performs sequence processing using a Transformer architecture. The output of the AI can take various forms, such as natural language text (e.g., “To use the defrost function, set the food and press the defrost button . . . ”), text for speech synthesis, or prompts for image generation. Examples of output include: (1) “The defrost function of this home appliance is . . . ”, (2) “The shortest route to the station is . . . ”, (3) “The assembly procedure is . . . ” The response is presented in various ways, such as display on the user terminal screen, reading aloud by speech synthesis, or AR display. Subsequent processing includes threshold determination based on the confidence score of the AI output (e.g., 0.92), acceptance of additional questions from the user, and history management. Unlike conventional human explanations or guidance operations, the present system can provide vast amounts of object information in real time and personalized manner by combining tag information and AI. The AI model uses pre-trained parameters and can be optimized for specific categories (home appliances, furniture, maps, etc.) through additional training or fine-tuning. The technical effects of the present system include: (1) improvement of immediacy and convenience of information acquisition, (2) automatic optimization of explanation content, (3) support for multiple languages and modalities, (4) personalization for each user, (5) reduction of manual work and operational costs, (6) immediate reflection of information updates, and (7) improved accessibility for visually and hearing impaired users. Application fields include instruction manuals for home appliances, assembly support for furniture, guidance for public facilities, multilingual guides for tourist spots, presentation of teaching materials in educational settings, maintenance guidance for factory equipment, and operation instructions for medical devices. Furthermore, the types of information tags, AI model configurations, and response presentation methods can be varied according to the application and user attributes, providing excellent system scalability and flexibility.

The information provision system according to the embodiment comprises a collection unit, a generation unit, a reading unit, a response generation unit, and a provision unit. The collection unit collects information regarding objects. The information regarding objects includes, for example, home appliances, furniture, map bulletin boards, and public facilities, but is not limited to such examples. The collection unit can collect, for example, specifications and usage methods of home appliances, maintenance information of furniture, location information of map bulletin boards, and usage guidance of public facilities. The generation unit generates a prompt based on the information collected by the collection unit. The prompt may be in the form of a question or instruction, and serves as input for the generative AI to generate a response. The generation unit generates prompts such as “Tell me how to use this home appliance” or “How do I get from XX to XX?” based on the collected information. The reading unit reads the information tag. The information tag may include, for example, QR codes, barcodes, NFC tags, but is not limited to such examples. The reading unit can read the information tag using, for example, a smartphone camera or NFC reader. The response generation unit analyzes the prompt read by the reading unit and generates a response. The response may be in the form of text, audio, or image, and is generated by the generative AI based on the prompt. The response generation unit can generate responses such as “The usage method of this home appliance is XX” or “To get from XX to XX, please go through XX” using the generative AI. The provision unit provides the response generated by the response generation unit to the user. The provision unit can display text or images on the screen of a smartphone or play the response as audio. Thus, the information provision system according to the embodiment can collect information regarding objects, generate prompts, read information tags, generate responses, and provide them to the user. Some or all of the above-described processing in the response generation unit may be performed using generative AI, or may be performed without using generative AI. For example, the response generation unit can generate a response using a generative AI model that takes a prompt as input and outputs a response. Specifically, the information provision system not only automates conventional human explanation and guidance operations through cooperation among the units, but also realizes fundamental improvements in computer technology. The system allows the collection unit to acquire structured data in JSON or CSV format from databases or APIs on the Internet, and manages the acquired data internally as feature vectors (e.g., numerical vectors of length 10 to 50 with elements such as model number, power consumption, usage scene for home appliances). The generation unit receives the feature vector from the collection unit as input and generates natural language prompts using rule-based template generation algorithms or Transformer-based large-scale language models (with 1 billion to 100 billion parameters). For example, when given an input vector such as “{model number: AB123, function: defrost, usage scene: breakfast preparation}”, the generation unit generates a prompt such as “Tell me how to use the defrost function of this microwave oven.” The reading unit takes image data obtained from the user terminal's camera (e.g., RGB image tensor with resolution 1920×1080 pixels) or byte sequence data from an NFC reader as input, and detects and decodes QR codes or NFC tags using image processing libraries such as OpenCV or deep learning-based object detection models (e.g., YOLOv5). The output of the reading unit is a tag ID or encoded prompt information (e.g., UTF-8 string). The response generation unit tokenizes the prompt received from the reading unit, converts it into an embedding vector (e.g., floating-point vector of length 2048), and generates a response sentence through the encoder-decoder layers of the Transformer architecture. The output of the AI model can take various forms, such as natural language text (e.g., “To use the defrost function of this home appliance, set the food and press the defrost button . . . ”), text for speech synthesis, or prompts for image generation. Examples of output include “The usage method of this home appliance is . . . ” and “To get from XX to XX, please go through . . . ” The provision unit not only displays the text data received from the response generation unit on the user interface, but can also input it to a speech synthesis engine (e.g., Tacotron2 or WaveNet) to generate audio data (e.g., 16 kHz, 16 bit PCM) and play it through a speaker. Furthermore, the provision unit can assign a confidence score (e.g., 0.95) or category label (e.g., “home appliance,” “map”) to the response and use it for subsequent branching processing or history management. Unlike conventional human operations, the present system is characterized by the integration and optimization of information using sequence processing and attention mechanisms in high-dimensional vector space by the AI model. The technical effects of the present system include improvement of immediacy and convenience of information acquisition, automatic optimization of explanation content, support for multiple languages and modalities, personalization for each user, reduction of manual work and operational costs, immediate reflection of information updates, and improved accessibility. Application fields include instruction manuals for home appliances, assembly support for furniture, guidance for public facilities, multilingual guides for tourist spots, presentation of teaching materials in educational settings, maintenance guidance for factory equipment, and operation instructions for medical devices. Furthermore, the AI models and algorithms of each unit can be varied according to the application and user attributes, providing excellent system scalability and flexibility.

The collection unit can collect information regarding objects such as home appliances, furniture, map bulletin boards, and public facilities. The collection unit can collect, for example, specifications and usage methods of home appliances, maintenance information of furniture, location information of map bulletin boards, and usage guidance of public facilities. Thus, information regarding various objects can be collected. Some or all of the above-described processing in the collection unit may be performed using AI, or may be performed without using AI. For example, the collection unit can input specification information of home appliances to AI, and the AI can automatically collect information. Specifically, the collection unit acquires data in JSON or XML format from public APIs on the Internet or internal databases, parses the acquired data, and stores it in an internal structured database (e.g., SQL table, NoSQL document store). The collection unit generates a vector (e.g., a mixed vector of numbers and strings of length 10) as specification information for home appliances, including attributes such as model number, power consumption, dimensions, supported functions, and manufacturing date. For furniture, it includes material, assembly procedure, recommended tools, and maintenance cycle. For map bulletin boards, it collects latitude/longitude, installation location, surrounding facility information, and update date. For public facilities, it collects facility name, available hours, barrier-free information, and emergency contact information. When using AI, the collection unit utilizes web scraping engines and natural language processing models (e.g., BERT-based information extraction models) to extract and normalize necessary information from unstructured text. Examples of input include HTML data of web pages and text data of PDF manuals. The AI tokenizes these inputs, extracts important terms and recognizes entities, and outputs structured information vectors (e.g., {model number: AB123, power consumption: 800W, function: defrost}). As subsequent processing, the collected information is indexed by category and used as input for the generation unit and response generation unit. Unlike conventional manual collection, the present collection unit can process large amounts of data quickly and accurately, greatly improving the comprehensiveness, freshness, and reliability of information. The technical effects include automation and efficiency of information collection, improved scalability of the database, immediate reflection of information updates, and quick response to user requests. Application fields include product information management for home appliance and furniture manufacturers, guidance systems for public facilities, information provision for tourist spots, and construction of teaching material databases in educational settings.

The generation unit can generate prompts based on the collected information. The generation unit generates prompts such as “Tell me how to use this home appliance” or “How do I get from XX to XX?” based on the collected information. Thus, prompts can be generated based on the collected information. Some or all of the above-described processing in the generation unit may be performed using generative AI, or may be performed without using generative AI. For example, the generation unit can input the collected information to generative AI, and the generative AI can automatically generate prompts. Specifically, the generation unit receives structured data (e.g., attribute vectors of home appliances or maintenance information of furniture) from the collection unit as input, and generates natural language prompts using rule-based template engines or large-scale language models (LLMs). In the case of a template engine, attribute values are embedded in a predetermined sentence pattern to automatically generate prompts such as “Tell me how to use the defrost function of this microwave oven.” When using AI, examples of input include vectors such as “{model number: AB123, function: defrost, usage scene: breakfast preparation}” or information such as “map bulletin board, destination: station, current location: park.” The generative AI tokenizes these inputs, converts them into embedding vectors (e.g., floating-point vectors of length 1024), and outputs appropriate question or instruction prompts through sequence processing using a Transformer architecture. Examples of output include “Tell me how to use this home appliance” and “How do I get from the park to the station?” As subsequent processing, the generated prompts are encoded into information tags and used as input for the reading unit and response generation unit. Unlike conventional manual generation, the present generation unit can quickly generate consistent and comprehensive prompts from large amounts of information, greatly improving the immediacy and personalization of information provision. The technical effects include automation and optimization of prompt generation, flexible response to user requests, multilingual support, and immediate reflection of information updates. Application fields include instruction manuals for home appliances and furniture, guidance for public facilities, guides for tourist spots, and presentation of teaching materials in educational settings.

The reading unit can read information tags. The information tag may include, for example, QR codes, barcodes, NFC tags, but is not limited to such examples. The reading unit can read the information tag using, for example, a smartphone camera or NFC reader. Thus, the reading unit can read information tags. Some or all of the above-described processing in the reading unit may be performed using AI, or may be performed without using AI. For example, the reading unit can input the information tag to AI, and the AI can automatically read the information. Specifically, the reading unit receives image data obtained from the user terminal's camera (e.g., RGB image tensor with resolution 1280×720 pixels) or byte sequence data from an NFC reader as input, and detects and decodes information tags using image processing algorithms (e.g., QR code detection by OpenCV) or deep learning-based object detection models (e.g., YOLOv5). When using AI, examples of input include camera image tensors and binary data of NFC tags. The AI extracts feature maps from the image, segments the tag area, and performs decoding processing. The output is a tag ID or encoded prompt information (e.g., UTF-8 string). As subsequent processing, the read tag information is used as input for the generation unit and response generation unit. Unlike conventional visual inspection or manual input, the present reading unit supports various tag formats and realizes fast and highly accurate automatic recognition. The technical effects include automation and improved accuracy of tag reading, reduction of user burden, improved immediacy of information acquisition, and support for various devices. Application fields include linkage with instruction manuals for home appliances and furniture, guidance for public facilities, information provision for tourist spots, and maintenance management for factory equipment.

The response generation unit can analyze the read prompt and generate a response. The prompt may be in the form of a question or instruction, and serves as input for the generative AI to generate a response. The response may be in the form of text, audio, or image, and is generated by the generative AI based on the prompt. The response generation unit can generate responses such as “The usage method of this home appliance is XX” or “To get from XX to XX, please go through XX” using the generative AI. Thus, the response generation unit can analyze the read prompt and generate a response. Some or all of the above-described processing in the response generation unit may be performed using generative AI, or may be performed without using generative AI. For example, the response generation unit can generate a response using a generative AI model that takes a prompt as input and outputs a response. Specifically, the response generation unit receives the prompt (e.g., natural language text such as “Tell me how to use this home appliance”) from the reading unit as input, tokenizes it, converts it into an embedding vector (e.g., floating-point vector of length 2048), and generates a response sentence through the encoder-decoder layers of the Transformer architecture. As the AI model, a pre-trained large-scale language model (with 1 billion to 100 billion parameters) or a multimodal generative model that integrally handles images, audio, and text can be used. Examples of input to the AI include: “Tell me how to use the defrost function of this microwave oven,” “Guide me from the park to the station by the shortest route,” “Explain the assembly procedure for this furniture.” The output of the AI can take various forms, such as natural language text (e.g., “To use the defrost function, set the food and press the defrost button . . . ”), text for speech synthesis, or prompts for image generation. Examples of output include “The usage method of this home appliance is . . . ” and “To get from XX to XX, please go through . . . ” As subsequent processing, the response is assigned a confidence score (e.g., 0.92) or category label (e.g., “home appliance,” “map”) and used for threshold determination or history management. Unlike conventional human explanations or guidance operations, the present response generation unit integrates and optimizes information using sequence processing and attention mechanisms in high-dimensional vector space, greatly improving the accuracy, immediacy, and personalization of responses. The technical effects include automation and optimization of response generation, support for various output formats, flexible response to user requests, and immediate reflection of information updates. Application fields include instruction manuals for home appliances and furniture, guidance for public facilities, guides for tourist spots, and presentation of teaching materials in educational settings.

The provision unit can provide the generated response to the user. The provision unit can display text or images on the screen of a smartphone or play the response as audio. Thus, the provision unit can provide the generated response to the user. Some or all of the above-described processing in the provision unit may be performed using AI, or may be performed without using AI. For example, the provision unit can input the generated response to AI, and the AI can automatically provide the response. Specifically, the provision unit receives response data (e.g., natural language text, text for speech synthesis, prompts for image generation, etc.) from the response generation unit as input and distributes it to multiple output modules such as a user interface module, speech synthesis engine, and image display module. For example, in the case of a text response, the provision unit uses a text rendering engine to display the response sentence on the screen of a smartphone or tablet. In the case of an audio response, the provision unit inputs the text data to a speech synthesis engine (e.g., Tacotron2 or WaveNet-compatible engine) to generate audio data in 16 kHz, 16 bit PCM format and plays it through the terminal's speaker. In the case of an image response, the provision unit inputs the prompt to an image generation module and displays the generated image (e.g., PNG, JPEG format) on the screen. When using AI, the provision unit inputs the response data and user attributes (e.g., terminal type, screen size, accessibility settings, etc.) to the AI model, and the AI determines the optimal output format (e.g., text, audio, image, AR display, etc.) and presentation timing. Examples of input include: (1) text such as “The usage method of this home appliance is XX,” (2) instructions such as “Guide me to the station by audio,” (3) requests such as “Display an image of the furniture assembly procedure.” The output of the AI is structured data such as (1) text display instructions, (2) audio playback instructions, (3) image display instructions. As subsequent processing, the provision unit controls the hardware resources of the user terminal (display, speaker, vibration, etc.) according to the AI output and presents the response immediately and in an appropriate format. Furthermore, after presenting the response, the provision unit monitors user operations (e.g., additional questions, playback stop, zoom display, etc.) and records interaction history to optimize the response presentation method for future use. Unlike conventional simple screen display or audio playback, the present provision unit realizes advanced improvements in computer technology, such as optimization of output format and timing by AI, dynamic response presentation according to user attributes and terminal status, and integrated presentation of multiple modalities. The technical effects include improvement of immediacy, flexibility, and personalization of response presentation, enhancement of accessibility support, improvement of user satisfaction, and efficient utilization of terminal resources. Application fields include instruction manuals for home appliances and furniture, guidance for public facilities, multilingual guides for tourist spots, presentation of teaching materials in educational settings, operation instructions for medical devices, and maintenance guidance for factory equipment. Furthermore, the configuration of the provision unit and AI models can be varied according to the application and user attributes, providing excellent system scalability and flexibility.

The response generation unit can also generate responses to the user's questions. The response generation unit can generate responses to the user's questions using generative AI, for example. For example, if the user asks “Tell me about a specific function of this home appliance,” the generative AI generates a response to that question. Thus, the response generation unit can also generate responses to the user's questions. Some or all of the above-described processing in the response generation unit may be performed using generative AI, or may be performed without using generative AI. For example, the response generation unit can input the user's question to generative AI, and the generative AI can automatically generate a response. Specifically, the response generation unit receives natural language text input from the user terminal (e.g., “Tell me the details of the defrost function of this microwave oven,” “What tools are needed to assemble this furniture,” “Tell me about cafes near this map bulletin board,” etc.), tokenizes it, and converts it into an embedding vector (e.g., floating-point vector of length 2048). The response generation unit uses the encoder-decoder layers of the Transformer architecture to perform semantic analysis and contextual understanding of the input question, refers to relevant knowledge bases and pre-trained parameters, and generates the optimal response sentence. As the AI model, a large-scale language model with 1 billion to 100 billion parameters or a multimodal generative model that integrally handles images, audio, and text can be used. Examples of input to the AI include: (1) “Tell me how to use the energy-saving mode of this home appliance,” (2) “What is the maintenance cycle for this furniture,” (3) “Guide me along a barrier-free route from this map bulletin board to the station.” The output of the AI is natural language text such as (1) “To use the energy-saving mode, press and hold the setting button . . . ”, (2) “The maintenance cycle is every six months . . . ”, (3) “The barrier-free route uses the elevator . . . ” As subsequent processing, the response generation unit assigns a confidence score (e.g., 0.93) or category label (e.g., “home appliance,” “furniture,” “map”) to the generated response and sends it to the provision unit. Furthermore, it cooperates with additional questions from the user and history management functions to realize interactive information provision. Unlike conventional FAQs or static manual references, the present response generation unit uses sequence processing and attention mechanisms in high-dimensional vector space to generate immediate and personalized responses to diverse user questions, greatly improving the accuracy, flexibility, and immediacy of information provision. The technical effects include flexible response to user requests, automation and optimization of response generation, immediate reflection of information updates, and realization of interactive interfaces. Application fields include instruction manuals for home appliances and furniture, guidance for public facilities, guides for tourist spots, presentation of teaching materials in educational settings, and operation instructions for medical devices.

The collection unit can estimate the user's emotion and determine the priority of information to be collected based on the estimated emotion of the user. For example, when the user is excited, the collection unit prioritizes the collection of information that the user is likely to be interested in. For example, when the user is tired, the collection unit prioritizes the collection of concise and important information. For example, when the user is relaxed, the collection unit prioritizes the collection of detailed and comprehensive information. Thus, the collection unit can determine the priority of information to be collected based on the user's emotion. Emotion estimation is realized using, for example, an emotion engine or generative AI with emotion estimation functions. The generative AI may be a text generation AI (e.g., LLM) or a multimodal generative AI, but is not limited to such examples. Some or all of the above-described processing in the collection unit may be performed using AI, or may be performed without using AI. For example, the collection unit can input the user's emotion data to generative AI, and the generative AI can automatically determine the priority of information. Specifically, the collection unit receives emotion data obtained from the user terminal (e.g., voice tone, facial expression image, emotional vocabulary in text input, biometric sensor data such as heart rate) as input, and outputs emotion labels such as “excited,” “fatigued,” “relaxed” and confidence scores (e.g., 0.87) using emotion estimation AI (e.g., BERT-based emotion classification model or multimodal emotion estimation model). Examples of input include (1) text such as “Yay! My new home appliance has arrived!”, (2) a smiling face image, (3) increased heart rate data. The AI output is (1) “excited” label, (2) “relaxed” label, (3) “fatigued” label and respective confidence scores. The collection unit dynamically changes the priority parameters of the information collection algorithm according to the emotion label, prioritizing entertainment or highly novel information when “excited,” concise key information when “fatigued,” and detailed comprehensive information when “relaxed.” As subsequent processing, the collected information is used as input for the generation unit and response generation unit, realizing personalization of the user experience. Unlike conventional uniform information collection, the present collection unit combines AI-based emotion estimation and information priority control to provide information optimized for the user's psychological state, preventing information overload and inappropriate information presentation. The technical effects include improved personalization of information collection, increased user satisfaction, optimized information presentation, and enhanced system response flexibility. Application fields include instruction manuals for home appliances and furniture, guidance for public facilities, guides for tourist spots, presentation of teaching materials in educational settings, and operation instructions for medical devices.

The collection unit can monitor the frequency and status of use of the object in real time and collect information at an appropriate timing. For example, the collection unit monitors the frequency of use of home appliances and collects detailed information when the frequency is high. For example, the collection unit monitors the status of use of furniture and collects maintenance information according to the status. For example, the collection unit monitors the usage status of map bulletin boards and collects the latest route guidance information during times when there are many users. Thus, the collection unit can monitor the frequency and status of use of the object in real time and collect information at an optimal timing. Some or all of the above-described processing in the collection unit may be performed using AI, or may be performed without using AI. For example, the collection unit can input frequency of use data of home appliances to AI, and the AI can automatically collect information. Specifically, the collection unit receives usage frequency data obtained from IoT sensors or user terminals (e.g., number of times a home appliance is turned on/off per day, open/close sensor values for furniture, number of touches or access logs for map bulletin boards) as input, and extracts usage patterns and peak timings using time series analysis AI (e.g., LSTM or GRU-based recurrent neural networks) or statistical anomaly detection algorithms. Examples of input include (1) “Number of times the microwave oven is used per day: 10 times,” (2) “Chair seating sensor value: 8 hours per day,” (3) “Number of accesses to the map bulletin board: maximum during 6 p.m. on weekdays.” The AI output is (1) “high frequency use” label, (2) “maintenance recommended” flag, (3) “information update required” alert as structured data. The collection unit prioritizes the collection of detailed instructions, maintenance information, and the latest route guidance information based on these outputs. As subsequent processing, the collected information is used as input for the generation unit and response generation unit, realizing optimal information provision to the user. Unlike conventional periodic and uniform information collection, the present collection unit combines AI-based real-time monitoring and dynamic information collection control to greatly improve the freshness, relevance, and immediacy of information. The technical effects include improved efficiency of information collection, quick response to user requests, reduced maintenance costs, and immediate reflection of information updates. Application fields include maintenance management for home appliances and furniture, guidance for public facilities, information provision for tourist spots, and updating teaching materials in educational settings.

The collection unit can detect a change in the state of the object and collect the information thereof. For example, the collection unit detects a failure of a home appliance and collects information regarding the failure. For example, the collection unit detects the timing for maintenance of furniture and collects information regarding maintenance. For example, the collection unit detects a change in the state of equipment in public facilities and collects information regarding the equipment. Thus, the collection unit can detect a change in the state of the object and collect the information thereof. Some or all of the above-described processing in the collection unit may be performed using AI, or may be performed without using AI. For example, the collection unit can input failure data of home appliances to AI, and the AI can automatically collect information. Specifically, the collection unit receives state data obtained from IoT sensors or terminals (e.g., error logs of home appliances, usage count counters for furniture, operating status sensor values for public facility equipment) as input, and automatically determines deviations from normal state or arrival of maintenance timing using anomaly detection AI (e.g., autoencoder-based anomaly detection models or time series clustering algorithms). Examples of input include (1) “Refrigerator temperature sensor value is out of the specified range,” (2) “Chair open/close count exceeds cumulative 10,000 times,” (3) “Air conditioning equipment operating rate drops sharply.” The AI output is (1) “failure detected” flag, (2) “maintenance recommended” alert, (3) “equipment anomaly” label as structured data. The collection unit prioritizes the collection of relevant failure information, maintenance procedures, and detailed information regarding changes in equipment state based on these outputs. As subsequent processing, the collected information is used as input for the generation unit and response generation unit, realizing prompt information provision and maintenance response to the user. Unlike conventional visual inspection or periodic patrols, the present collection unit combines AI-based automatic state monitoring and anomaly detection to realize early detection of failures and maintenance timing, improved immediacy and accuracy of information collection, and reduced operational costs. The technical effects include improved efficiency of maintenance management, minimized downtime, increased user satisfaction, and immediate reflection of information updates. Application fields include maintenance management for home appliances and furniture, equipment monitoring for public facilities, anomaly detection for factory equipment, and state monitoring for medical devices.

The collection unit can estimate the user's emotion and adjust the level of detail of information to be collected based on the estimated emotion of the user. For example, when the user is excited, the collection unit collects detailed information. For example, when the user is tired, the collection unit collects concise information. For example, when the user is relaxed, the collection unit collects comprehensive information. Thus, the collection unit can adjust the level of detail of information to be collected based on the user's emotion. Emotion estimation is realized using, for example, an emotion engine or generative AI with emotion estimation functions. The generative AI may be a text generation AI (e.g., LLM) or a multimodal generative AI, but is not limited to such examples. Some or all of the above-described processing in the collection unit may be performed using AI, or may be performed without using AI. For example, the collection unit can input the user's emotion data to generative AI, and the generative AI can automatically adjust the level of detail of information. Specifically, the collection unit receives emotion data obtained from the user terminal (e.g., spectral features of voice tone, facial landmark vectors from expression images, distribution of emotional vocabulary in natural language text input, time series data of biometric signals such as heart rate and skin conductance) as input. The collection unit inputs these diverse data to pre-trained emotion classification models such as BERT or RoBERTa, or multimodal emotion estimation models that integrally handle voice, image, and biometric signals (e.g., ResNet+LSTM hybrid model). The AI model performs preprocessing such as tokenization, normalization, and feature extraction (e.g., MFCC extraction, facial feature point extraction, time series pattern extraction) on the input data and outputs emotion labels (e.g., “excited,” “fatigued,” “relaxed”) and confidence scores (e.g., 0.91). Examples of input include (1) text such as “Yay! My new home appliance has arrived!”, (2) a smiling face image (128×128 pixel RGB tensor), (3) one minute of time series data showing increased heart rate (sampling rate 1 Hz, 60-dimensional vector). The AI output is (1) “excited” label and 0.93 confidence, (2) “relaxed” label and 0.88 confidence, (3) “fatigued” label and 0.85 confidence. The collection unit dynamically changes the parameters of the information collection algorithm (e.g., detail score threshold, category weights, number of information elements) according to the emotion label. For example, when “excited,” the detail score is set high, and the entire specification, detailed procedures, and related FAQs are comprehensively collected. When “fatigued,” a key point extraction algorithm (e.g., TextRank or BERT summarizer) is applied to collect only concise summary information. When “relaxed,” comprehensive information (e.g., background knowledge, hints, related topics) is widely collected. As subsequent processing, the collected information is used as input for the generation unit and response generation unit, realizing personalization of the user experience. Unlike conventional uniform information collection, the present collection unit combines AI-based emotion estimation and control of information detail to provide information optimized for the user's psychological state and situation, preventing information overload and inappropriate information presentation. The technical effects include improved personalization of information collection, increased user satisfaction, optimized information presentation, enhanced system response flexibility, and reduced cognitive load due to information overload. Application fields include instruction manuals for home appliances and furniture, guidance for public facilities, guides for tourist spots, presentation of teaching materials in educational settings, operation instructions for medical devices, rehabilitation support, and provision of stress care information. Furthermore, emotion estimation AI models and information detail control algorithms can be varied according to the application and user attributes, providing excellent system scalability and flexibility.

The collection unit can preferentially collect information related to a specific region or environment based on the location information of the object. For example, the collection unit considers the location information of home appliances and collects information regarding the regional power supply status. For example, the collection unit considers the location information of furniture and collects information regarding the regional climate conditions. For example, the collection unit considers the location information of map bulletin boards and collects information regarding the regional traffic conditions. Thus, the collection unit can preferentially collect information related to a specific region or environment based on the location information of the object. Some or all of the above-described processing in the collection unit may be performed using AI, or may be performed without using AI. For example, the collection unit can input the location information of the object to AI, and the AI can automatically collect information. Specifically, the collection unit receives location information assigned to the object (e.g., GPS coordinates, Wi-Fi access point ID, indoor beacon ID, address string) as input. The collection unit links this location information with GIS APIs or open databases (e.g., OpenStreetMap, Meteorological Agency API, Power Company API) to automatically collect region-specific information (e.g., power supply status, temperature, humidity, precipitation, traffic congestion information, disaster alerts, surrounding facility information). When using AI, the collection unit inputs location information vectors (e.g., two-dimensional floating-point vectors of latitude and longitude, or combinations of location ID and category label) and applies geographic feature extraction models (e.g., Graph Neural Network or spatial clustering algorithms) or spatiotemporal data analysis AI (e.g., time series LSTM+spatial CNN hybrid model). Examples of input include (1) GPS coordinates “latitude 35.6895, longitude 139.6917,” (2) “indoor beacon ID: B1234,” (3) “address: Chiyoda-ku, Tokyo.” The AI output is structured information such as (1) “regional power supply: stable, caution during peak hours,” (2) “climate conditions: high humidity, ventilation recommended,” (3) “traffic conditions: congested.” The collection unit dynamically adjusts the priority parameters of the information collection algorithm (e.g., category weights, collection frequency, information freshness threshold) based on these outputs, and preferentially collects information optimized for the region or environment. As subsequent processing, the collected information is used as input for the generation unit and response generation unit, realizing region-adaptive information provision to the user. Unlike conventional uniform information collection, the present collection unit combines AI-based location information analysis and information collection control to provide information responsive to regional characteristics and environmental changes, greatly improving user convenience and safety. The technical effects include regional optimization of information collection, improved responsiveness to environmental changes, increased user satisfaction, rapid information provision during disasters, and efficient energy management. Application fields include region-optimized settings for home appliances and furniture, guidance for public facilities, local guides for tourist spots, presentation of regional teaching materials in educational settings, environmental monitoring for factory equipment, and adaptation of installation environments for medical devices. Furthermore, location information analysis AI models and information collection algorithms can be varied according to the application and regional characteristics, providing excellent system scalability and flexibility.

The collection unit can collect manufacturer or brand information of the object and improve the reliability of information provided to the user. For example, the collection unit collects manufacturer information of home appliances and provides highly reliable information. For example, the collection unit collects brand information of furniture and provides highly reliable information. For example, the collection unit collects manufacturer information of map bulletin boards and provides highly reliable information. Thus, the collection unit can collect manufacturer or brand information of the object and improve the reliability of information provided to the user. Some or all of the above-described processing in the collection unit may be performed using AI, or may be performed without using AI. For example, the collection unit can input manufacturer information of the object to AI, and the AI can automatically collect information. Specifically, the collection unit receives manufacturer or brand information assigned to the object (e.g., manufacturer name, brand name, product model number, manufacturing date, certification number as attribute vectors) as input. The collection unit links this information with official manufacturer APIs, industry standard databases (e.g., UL certification database, GS1 product code database), and open data from public certification organizations to automatically collect highly reliable information (e.g., official specifications, certification history, recall information, support contact information). When using AI, the collection unit inputs manufacturer information vectors (e.g., {manufacturer name: ABC, model number: 1234, certification number: 5678}) and applies information reliability evaluation models (e.g., BERT-based fact-checking AI or knowledge graph inference models). Examples of input include (1) “manufacturer name: ABC, model number: 1234,” (2) “brand name: XYZ, manufacturing date: 2023 Jan. 1,” (3) “certification number: 5678.” The AI output is structured data such as (1) “reliability: high, refer to official information,” (2) “recall history: none,” (3) “support contact: valid.” The collection unit assigns reliability scores and source information to the information provided to the user based on these outputs, and preferentially collects and presents only highly reliable information. As subsequent processing, the collected information is used as input for the generation unit and response generation unit, realizing information provision with reliability assurance to the user. Unlike conventional manual information collection or presentation of information with unknown sources, the present collection unit combines AI-based reliability evaluation and linkage with official databases to greatly improve the accuracy, reliability, and transparency of information. The technical effects include improved reliability of information provision, elimination of misinformation and disinformation, increased user satisfaction, enhanced product traceability, and efficient support response. Application fields include product information management for home appliances and furniture, equipment management for public facilities, certification management for factory equipment, provision of safety information for medical devices, and reliability assurance for teaching materials in educational settings. Furthermore, reliability evaluation AI models and information collection algorithms can be varied according to the application and industry standards, providing excellent system scalability and flexibility.

The generation unit can estimate the user's emotion and adjust the expression method of the prompt based on the estimated emotion of the user. For example, when the user is relaxed, the generation unit generates prompts in a friendly expression method. For example, when the user is in a hurry, the generation unit generates prompts in a concise and clear expression method. For example, when the user is excited, the generation unit generates prompts in a lively expression method. Thus, the generation unit can adjust the expression method of the prompt based on the user's emotion. Emotion estimation is realized using, for example, an emotion engine or generative AI with emotion estimation functions. The generative AI may be a text generation AI (e.g., LLM) or a multimodal generative AI, but is not limited to such examples. Some or all of the above-described processing in the generation unit may be performed using AI, or may be performed without using AI. For example, the generation unit can input the user's emotion data to generative AI, and the generative AI can automatically adjust the expression method of the prompt. Specifically, the generation unit receives emotion data obtained from the user terminal (e.g., spectral features of voice tone, facial landmark vectors from expression images, distribution of emotional vocabulary in natural language text input, time series data of biometric signals such as heart rate and skin conductance) as input. The generation unit inputs these diverse data to pre-trained emotion classification models such as BERT or RoBERTa, or multimodal emotion estimation models that integrally handle voice, image, and biometric signals (e.g., ResNet+LSTM hybrid model). The AI model performs preprocessing such as tokenization, normalization, and feature extraction (e.g., MFCC extraction, facial feature point extraction, time series pattern extraction) on the input data and outputs emotion labels (e.g., “relaxed,” “in a hurry,” “excited”) and confidence scores (e.g., 0.91). Examples of input include (1) text such as “Yay! My new home appliance has arrived!”, (2) a smiling face image (128×128 pixel RGB tensor), (3) one minute of time series data showing increased heart rate (sampling rate 1 Hz, 60-dimensional vector). The AI output is (1) “excited” label and 0.93 confidence, (2) “relaxed” label and 0.88 confidence, (3) “in a hurry” label and 0.85 confidence. The generation unit dynamically changes the parameters of the prompt generation algorithm (e.g., expression style, vocabulary selection, sentence template) according to the emotion label. For example, when “relaxed,” friendly vocabulary and polite style are automatically selected; when “in a hurry,” concise and clear imperative style is selected; when “excited,” lively style with frequent use of exclamation marks and emphatic expressions is selected. As the AI model, Transformer-based large-scale language models or prompt generation models with emotion control (e.g., Conditional LLM) can be used. Examples of input to the AI include (1) “relaxed” label+“how to use the microwave oven”→“Let me explain slowly. The usage method of the microwave oven is . . . ”, (2) “in a hurry” label+“route guidance to the station”→“The shortest route is . . . ”, (3) “excited” label+“features of the new product”→“Amazing! The features of this new product are . . . ” The AI output is (1) friendly explanation text, (2) concise instruction text, (3) lively introduction text. As subsequent processing, the generated prompt is encoded into the information tag or used as input for the response generation unit. Unlike conventional uniform prompt generation, the present generation unit combines AI-based emotion estimation and expression control to automatically generate prompts optimized for the user's psychological state and situation, greatly improving the personalization, satisfaction, and information transmission efficiency of the user experience. The technical effects include improved flexibility and diversity of prompt generation, immediate response to user requests, optimized information presentation, and reduced cognitive load. Application fields include instruction manuals for home appliances and furniture, guidance for public facilities, guides for tourist spots, presentation of teaching materials in educational settings, operation instructions for medical devices, rehabilitation support, and provision of stress care information. Furthermore, emotion estimation AI models and prompt expression control algorithms can be varied according to the application and user attributes, providing excellent system scalability and flexibility.

The generation unit can adjust the level of detail of the prompt based on the importance of the collected information. For example, for highly important information, the generation unit generates detailed prompts. For less important information, the generation unit generates concise prompts. For moderately important information, the generation unit generates prompts with an appropriate level of detail. Thus, the generation unit can adjust the level of detail of the prompt based on the importance of the collected information. Some or all of the above-described processing in the generation unit may be performed using generative AI, or may be performed without using generative AI. For example, the generation unit can input the collected information to generative AI, and the generative AI can automatically adjust the level of detail of the prompt. Specifically, the generation unit receives information vectors from the collection unit (e.g., specifications of home appliances, maintenance information of furniture, event information of map bulletin boards, etc., as mixed vectors of numbers and categories of length 10 to 50) and importance scores assigned to each piece of information (e.g., 0.95, 0.60, 0.30) as input. The generation unit dynamically adjusts the detail parameters of the prompt generation algorithm (e.g., length of explanation, number of elements, presence of specific examples, presence of supplementary information) based on the importance score. As the AI model, Transformer-based large-scale language models or prompt generation models with importance control (e.g., Conditional LLM) can be used. Examples of input to the AI include (1) importance 0.95+“safety features of the microwave oven”→“Let me explain in detail about the safety features of this microwave oven . . . ”, (2) importance 0.60+“assembly procedure for furniture”→“The assembly procedure is as follows . . . ”, (3) importance 0.30+“usage hours of the map bulletin board”→“Usage hours are from 8 a.m. to 8 p.m.” The AI output is (1) detailed explanation text, (2) instruction text with moderate detail, (3) concise guidance text. As subsequent processing, the generated prompt is encoded into the information tag or used as input for the response generation unit. Unlike conventional uniform prompt generation, the present generation unit combines AI-based importance control and detail adjustment to automatically generate optimal prompts according to the granularity and priority of information required by the user, greatly improving the efficiency of information transmission, user satisfaction, and reduction of cognitive load. The technical effects include optimization of prompt generation, improved personalization of information presentation, emphasis on important information, and prevention of information overload. Application fields include instruction manuals for home appliances and furniture, guidance for public facilities, guides for tourist spots, presentation of teaching materials in educational settings, operation instructions for medical devices, and maintenance guidance for factory equipment. Furthermore, importance evaluation AI models and prompt detail control algorithms can be varied according to the application and user attributes, providing excellent system scalability and flexibility.

The generation unit can apply different prompt generation algorithms according to the category of the object. For example, for home appliances, the generation unit applies a prompt generation algorithm specialized for usage instructions. For furniture, the generation unit applies a prompt generation algorithm specialized for maintenance instructions. For map bulletin boards, the generation unit applies a prompt generation algorithm specialized for route guidance. Thus, the generation unit can apply different prompt generation algorithms according to the category of the object. Some or all of the above-described processing in the generation unit may be performed using generative AI, or may be performed without using generative AI. For example, the generation unit can input category information of the object to generative AI, and the generative AI can automatically apply the prompt generation algorithm. Specifically, the generation unit receives category labels of the object from the collection unit (e.g., “home appliance,” “furniture,” “map bulletin board,” “public facility,” etc.) and category-specific attribute vectors (e.g., model number, function, usage scene for home appliances; material, assembly procedure for furniture; installation location, destination information for map bulletin boards) as input. The generation unit automatically switches the prompt generation algorithm (e.g., rule-based template, category-specific LLM, conditional generation model) according to the category label. As the AI model, large-scale language models fine-tuned for each category or two-stage models for category determination and prompt generation can be used. Examples of input to the AI include (1) category “home appliance”+“defrost function”→“Tell me how to use the defrost function of this home appliance,” (2) category “furniture”+“maintenance cycle”→“Tell me how to maintain this furniture,” (3) category “map bulletin board”+“destination: station”→“Tell me the route from XX to the station.” The AI output is (1) usage instruction prompt, (2) maintenance procedure prompt, (3) route guidance prompt. As subsequent processing, the generated prompt is encoded into the information tag or used as input for the response generation unit. Unlike conventional uniform prompt generation, the present generation unit combines AI-based category determination and algorithm switching to automatically generate prompts optimized for the type and application of the object, greatly improving the accuracy, flexibility, and user satisfaction of information provision. The technical effects include diversity and optimization of prompt generation, category-specific information provision, immediate response to user requests, and improved efficiency of information transmission. Application fields include instruction manuals for home appliances and furniture, guidance for public facilities, guides for tourist spots, presentation of teaching materials in educational settings, operation instructions for medical devices, and maintenance guidance for factory equipment. Furthermore, category determination AI models and prompt generation algorithms can be varied according to the application and category characteristics, providing excellent system scalability and flexibility.

The generation unit can estimate the user's emotion and adjust the length of the prompt based on the estimated emotion of the user. For example, when the user is in a hurry, the generation unit generates a short prompt that focuses on the main points. When the user is relaxed, the generation unit generates a longer prompt that includes detailed explanations. When the user is excited, the generation unit generates a prompt with visually stimulating effects. Thus, the length of the prompt can be adjusted based on the user's emotion. Emotion estimation is realized, for example, by using an emotion estimation function with an emotion engine or a generative AI. The generative AI may be a text generation AI (such as an LLM) or a multimodal generation AI, but is not limited to these examples. Some or all of the above-described processing in the generation unit may be performed using AI or without using AI. For example, the generation unit may input the user's emotion data to the generative AI, and the generative AI can automatically adjust the length of the prompt. Specifically, the generation unit receives emotion data obtained from the user terminal (e.g., voice tone, facial expression image, emotional vocabulary in text input, biometric sensor time-series data) as input, and outputs emotion labels such as “in a hurry,” “relaxed,” or “excited,” along with confidence scores, using an emotion estimation AI (e.g., a BERT-based emotion classification model or a multimodal emotion estimation model). Examples of input to the AI include: (1) “in a hurry” label+“directions to the station”→“The shortest route is . . . ”; (2) “relaxed” label+“how to use home appliances”→“I will explain slowly. How to use the microwave is . . . ”; (3) “excited” label+“features of a new product”→“Amazing! The features of this new product are . . . ”. The AI output includes (1) a short prompt focusing on the main points, (2) a long prompt with detailed explanations, and (3) a prompt with visual effects (e.g., including emojis or emphasis). The generation unit dynamically changes the length parameters (e.g., maximum token count, number of elements, presence of supplementary information) and expression style of the prompt generation algorithm according to the emotion label. In subsequent processing, the generated prompt is used for encoding into the information tag or as input to the response generation unit. Unlike conventional uniform prompt generation, the generation unit combines AI-based emotion estimation and length control to automatically generate prompts optimized for the user's psychological state and situation, greatly improving the efficiency of information transmission, user satisfaction, and reduction of cognitive load. Technical effects include improved flexibility and diversity of prompt generation, responsiveness to user requests, optimization of information presentation, and reduction of cognitive load. Application fields include instructions for home appliances and furniture, guidance in public facilities, tourist guides, educational material presentation, medical device operation instructions, rehabilitation support, and stress care information provision. Furthermore, the emotion estimation AI model and prompt length control algorithm can have various variations according to the application and user attributes, providing excellent system scalability and flexibility.

The generation unit can determine the priority of prompts based on the submission timing of the collected information. For example, the generation unit determines the priority of prompts based on the latest information. The generation unit may set a lower priority for prompts based on older information. The generation unit may set a medium priority for prompts based on information with a medium submission timing. Thus, the priority of prompts can be determined based on the submission timing of the collected information. Some or all of the above-described processing in the generation unit may be performed using generative AI or without using generative AI. For example, the generation unit may input the submission timing data of the collected information to the generative AI, and the generative AI can automatically determine the priority of the prompt. Specifically, the generation unit receives information vectors from the collection unit and submission timing data assigned to each piece of information (e.g., UNIX timestamps, date strings, elapsed days) as input. The generation unit dynamically adjusts the priority parameters (e.g., priority score, display order, output timing) of the prompt generation algorithm based on the submission timing data. AI models such as priority inference models considering submission timing or time-series data analysis AI (e.g., LSTM-based time-series classification models) can be used. Examples of input to the AI include: (1) submission timing “2024 Jun. 1”+“new features of home appliances”→“Prompt generated with high priority as latest information”; (2) submission timing “2023 Jan. 1”+“old model of furniture”→“Prompt generated with low priority and deferred”; (3) submission timing “2024 Mar. 15”+“event information on map bulletin board”→“Prompt generated with medium priority”. The AI output includes (1) high-priority prompt, (2) low-priority prompt, and (3) medium-priority prompt. In subsequent processing, the generated prompt is used for encoding into the information tag or as input to the response generation unit. Unlike conventional uniform prompt generation, the generation unit combines AI-based submission timing analysis and priority control to automatically generate optimal prompts according to the freshness and importance of information, greatly improving the immediacy of information transmission, user satisfaction, and the speed of reflecting information updates. Technical effects include improved immediacy and optimization of prompt generation, enhanced freshness of information presentation, rapid response to user requests, and immediate reflection of information updates. Application fields include instructions for home appliances and furniture, guidance in public facilities, tourist guides, educational material presentation, medical device operation instructions, and factory equipment maintenance guidance. Furthermore, submission timing analysis AI models and prompt priority control algorithms can have various variations according to the application and information characteristics, providing excellent system scalability and flexibility.

The generation unit can adjust the order of prompts based on the relevance of the collected information. For example, the generation unit generates prompts by prioritizing highly relevant information. The generation unit generates prompts by deferring less relevant information. The generation unit generates prompts by appropriately placing information with medium relevance. Thus, the order of prompts can be adjusted based on the relevance of the collected information. Some or all of the above-described processing in the generation unit may be performed using generative AI or without using generative AI. For example, the generation unit may input relevance data of the collected information to the generative AI, and the generative AI can automatically adjust the order of the prompts. Specifically, the generation unit receives information vectors from the collection unit and relevance scores assigned to each piece of information (e.g., 0.98, 0.65, 0.40) or relevance category labels (e.g., “home appliances-safety,” “furniture-maintenance,” “map-event”) as input. The generation unit dynamically adjusts the order parameters (e.g., display order, output priority, grouping order) of the prompt generation algorithm based on the relevance scores. AI models such as relevance inference models (e.g., BERT-based semantic similarity models or knowledge graph inference models) or prompt generation models with relevance control can be used. Examples of input to the AI include: (1) relevance 0.98+“safety features of home appliances”→“Prompt generated with highest priority”; (2) relevance 0.65+“assembly procedure of furniture”→“Prompt generated with medium order”; (3) relevance 0.40+“usage time of map bulletin board”→“Prompt generated with lowest priority”. The AI output includes (1) high-relevance prompt, (2) medium-relevance prompt, and (3) low-relevance prompt. In subsequent processing, the generated prompt is used for encoding into the information tag or as input to the response generation unit. Unlike conventional uniform prompt generation, the generation unit combines AI-based relevance analysis and order control to automatically generate optimal prompts according to the priority and context of information required by the user, greatly improving the efficiency of information transmission, user satisfaction, and reduction of cognitive load. Technical effects include optimization of prompt generation, enhanced personalization of information presentation, emphasis of relevant information, and prevention of information overload. Application fields include instructions for home appliances and furniture, guidance in public facilities, tourist guides, educational material presentation, medical device operation instructions, and factory equipment maintenance guidance. Furthermore, relevance evaluation AI models and prompt order control algorithms can have various variations according to the application and user attributes, providing excellent system scalability and flexibility.

The reading unit can estimate the user's emotion and adjust the method of reading the information tag based on the estimated emotion of the user. For example, when the user is nervous, the reading unit provides a simple and highly visible reading method. When the user is relaxed, the reading unit provides a reading method that includes detailed information. When the user is in a hurry, the reading unit provides a reading method that focuses on the main points. Thus, the method of reading the information tag can be adjusted based on the user's emotion. Emotion estimation is realized, for example, by using an emotion estimation function with an emotion engine or generative AI. The generative AI may be a text generation AI (such as an LLM) or a multimodal generation AI, but is not limited to these examples. Some or all of the above-described processing in the reading unit may be performed using AI or without using AI. For example, the reading unit may input the user's emotion data to the generative AI, and the generative AI can automatically adjust the method of reading the information tag. Specifically, the reading unit receives emotion data obtained from the user terminal (e.g., spectral features of voice tone, facial landmark vectors from expression images, emotional vocabulary distribution in natural language text input, time-series data from biometric sensors such as heart rate or skin conductance) as input. The reading unit inputs these diverse data to pre-trained emotion classification models such as BERT or RoBERTa, or multimodal emotion estimation models that handle voice, image, and biometric signals integratively (e.g., ResNet +LSTM hybrid models). The AI model performs preprocessing such as tokenization, normalization, and feature extraction (e.g., MFCC extraction, facial feature point extraction, time-series pattern extraction) on the input data and outputs emotion labels (e.g., “nervous,” “relaxed,” “in a hurry”) and confidence scores (e.g., 0.91). Examples of input to the AI include: (1) text such as “I'm anxious because it's my first time operating this,” (2) a nervous facial expression image (128×128 pixel RGB tensor), (3) one minute of time-series data showing increased heart rate (sampling rate 1 Hz, 60-dimensional vector). The AI output includes (1) “nervous” label and 0.93 confidence, (2) “relaxed” label and 0.88 confidence, (3) “in a hurry” label and 0.85 confidence. The reading unit dynamically changes the reading interface, guidance display, and method of presenting operation procedures (e.g., font size, color emphasis, animation presence, length of explanation) according to the emotion label. For example, when “nervous,” only large buttons and clear guides are displayed, and a confirmation dialog is added to prevent erroneous operation. When “relaxed,” detailed explanations, hints, and supplementary information are displayed. When “in a hurry,” only the minimum steps and main points are emphasized. AI models may use rule-based engines or conditional generation models to select optimal UI/UX patterns by combining emotion labels and reading conditions (e.g., tag type, device type, ambient light). Examples of AI output include: (1) “nervous”+“QR code”→“Display only a large scan button and one-step guide”; (2) “relaxed”+“NFC tag”→“Display detailed reading procedure and hints”; (3) “in a hurry”+“barcode”→“Immediate scan and display only main points”. In subsequent processing, the reading unit immediately switches the user interface layout and guidance content according to the AI output, providing an operation experience optimized for the user's psychological state. Unlike conventional uniform reading UIs, the reading unit combines AI-based emotion estimation and interface control to greatly reduce the user's psychological burden, prevent erroneous operation and operation delays, and significantly improve the success rate, efficiency, and satisfaction of information tag reading. Technical effects include improved personalization of reading operations, optimization of user experience, reduction of cognitive load, enhancement of accessibility, and increased flexibility of system response. Application fields include instructions for home appliances and furniture, guidance in public facilities, tourist information provision, educational material presentation, medical device operation support, rehabilitation support, and stress care information provision. Furthermore, emotion estimation AI models and reading interface control algorithms can have various variations according to the application and user attributes, providing excellent system scalability and flexibility.

The reading unit can select an appropriate reading method according to the type and performance of the user's device when reading the information tag. For example, when the user is using a smartphone, the reading unit provides a reading method adapted to the screen size. When the user is using a tablet, the reading unit provides a reading method optimized for a large screen. When the user is using a smartwatch, the reading unit provides a concise and highly visible reading method. Thus, the optimal reading method can be selected according to the type and performance of the user's device. Some or all of the above-described processing in the reading unit may be performed using AI or without using AI. For example, the reading unit may input the user's device information to the AI, and the AI can automatically select the optimal reading method. Specifically, the reading unit receives device information obtained from the user terminal (e.g., device type, screen resolution, CPU/GPU performance, OS version, camera performance, NFC support, battery level) as input. The reading unit inputs this device information to a device characteristic classification model (e.g., LightGBM or random forest-based device clustering model) or a rule-based reading method selection algorithm using device attribute vectors. The AI model normalizes and extracts features from the input data and outputs device categories (e.g., “smartphone,” “tablet,” “smartwatch”) and performance scores (e.g., high, medium, low). Examples of input to the AI include: (1) “Device type: smartphone, screen resolution: 1080×2400, NFC: yes”; (2) “Device type: tablet, screen resolution: 2560×1600, camera: high performance”; (3) “Device type: smartwatch, screen resolution: 320×320, battery: 80%”. The AI output includes (1) “Standard UI for smartphone +camera scan recommended,” (2) “Enlarged UI for tablet +detailed guide display,” (3) “Simple UI for smartwatch+NFC tap recommended” as reading method instructions. The reading unit automatically switches the user interface layout, button size, guidance display, and reading procedure (e.g., camera activation, NFC tap, barcode scan) based on the AI output. In subsequent processing, the reading unit dynamically optimizes image processing algorithm resolution and frame rate, NFC communication timeout values, etc., according to device performance. Unlike conventional uniform reading UIs, the reading unit combines AI-based device characteristic analysis and interface control to achieve optimal operability, visibility, and power saving for each user device, greatly improving the success rate, efficiency, and user satisfaction of information tag reading. Technical effects include improved device adaptability, efficiency of reading operations, optimization of user experience, enhancement of accessibility, and increased flexibility of system response. Application fields include instructions for home appliances and furniture, guidance in public facilities, tourist information provision, educational material presentation, medical device operation support, and wearable device integration. Furthermore, device characteristic classification AI models and reading method selection algorithms can have various variations according to the application and device evolution, providing excellent system scalability and flexibility.

The reading unit can improve reading accuracy according to the surrounding environment when reading the information tag. For example, in a bright environment, the reading unit adjusts the screen brightness to improve reading accuracy. In a noisy environment, the reading unit adjusts the sensitivity of voice input to improve reading accuracy. In a dark environment, the reading unit uses a flashlight to improve reading accuracy. Thus, reading accuracy can be improved according to the surrounding environment. Some or all of the above-described processing in the reading unit may be performed using AI or without using AI. For example, the reading unit may input environmental data to the AI, and the AI can automatically improve reading accuracy. Specifically, the reading unit receives environmental data obtained from sensors of the user terminal (e.g., illuminance sensor values, environmental noise level from microphone input, accelerometer values, indoor/outdoor determination by GPS, temperature and humidity sensor values) as input. The reading unit inputs this environmental data to an environmental state classification model (e.g., LightGBM or SVM-based environmental clustering model) or a multimodal environmental recognition AI (e.g., CNN+LSTM hybrid model). The AI model normalizes and extracts features from the input data and outputs environment categories (e.g., “bright,” “dark,” “noisy,” “quiet”) and environment scores (e.g., 0.95). Examples of input to the AI include: (1) illuminance sensor value: 800 lx, (2) microphone input noise level: 70 dB, (3) GPS: outdoor determination. The AI output includes (1) “bright environment”+“automatic screen brightness adjustment,” (2) “noisy”+“increase voice input sensitivity,” (3) “dark”+“automatic flashlight activation” as reading accuracy improvement instructions. The reading unit dynamically optimizes screen brightness, flashlight, microphone sensitivity, noise canceling, camera exposure settings, etc., using hardware control APIs of the terminal based on the AI output. In subsequent processing, the reading unit monitors environmental changes in real time and readjusts as necessary. Unlike conventional fixed reading settings, the reading unit combines AI-based environmental recognition and hardware control to greatly improve the success rate, accuracy, and user satisfaction of information tag reading in any environment. Technical effects include improved environmental adaptability, optimization of reading accuracy, enhancement of user experience, reduction of misrecognition and failure rate, and increased flexibility of system response. Application fields include instructions for home appliances and furniture, guidance in public facilities, tourist information provision, educational material presentation, medical device operation support, and information provision at outdoor/indoor events. Furthermore, environmental recognition AI models and hardware control algorithms can have various variations according to the application and device evolution, providing excellent system scalability and flexibility.

The reading unit can estimate the user's emotion and adjust the timing of reading the information tag based on the estimated emotion of the user. For example, when the user is nervous, the reading unit reads the information tag at a calm timing. When the user is relaxed, the reading unit reads the information tag at any timing. When the user is in a hurry, the reading unit reads the information tag quickly. Thus, the timing of reading the information tag can be adjusted based on the user's emotion. Emotion estimation is realized, for example, by using an emotion estimation function with an emotion engine or generative AI. The generative AI may be a text generation AI (such as an LLM) or a multimodal generation AI, but is not limited to these examples. Some or all of the above-described processing in the reading unit may be performed using AI or without using AI. For example, the reading unit may input the user's emotion data to the generative AI, and the generative AI can automatically adjust the timing of reading the information tag. Specifically, the reading unit receives emotion data obtained from the user terminal (e.g., spectral features of voice tone, facial landmark vectors from expression images, emotional vocabulary distribution in natural language text input, time-series data from biometric sensors such as heart rate or skin conductance) as input. The reading unit inputs these diverse data to pre-trained emotion classification models such as BERT or RoBERTa, or multimodal emotion estimation models that handle voice, image, and biometric signals integratively (e.g., ResNet+LSTM hybrid models). The AI model performs preprocessing such as tokenization, normalization, and feature extraction (e.g., MFCC extraction, facial feature point extraction, time-series pattern extraction) on the input data and outputs emotion labels (e.g., “nervous,” “relaxed,” “in a hurry”) and confidence scores (e.g., 0.91). Examples of input to the AI include: (1) text such as “I'm anxious because it's my first time operating this,” (2) a nervous facial expression image (128×128 pixel RGB tensor), (3) one minute of time-series data showing increased heart rate (sampling rate 1 Hz, 60-dimensional vector). The AI output includes (1) “nervous” label and 0.93 confidence, (2) “relaxed” label and 0.88 confidence, (3) “in a hurry” label and 0.85 confidence. The reading unit dynamically changes the timing control algorithm (e.g., timing window setting, user operation waiting time, guidance display timing) according to the emotion label. For example, when “nervous,” relaxation guidance is displayed before prompting user operation, and reading starts after waiting for a certain period. When “relaxed,” user operations are accepted immediately. When “in a hurry,” reading operations are accepted immediately and guidance display is omitted. AI models may use rule-based engines or conditional generation models to select optimal timing control patterns by combining emotion labels and user operation history. In subsequent processing, the reading unit immediately switches the timing control and guidance display of the user interface according to the AI output, providing an operation experience optimized for the user's psychological state. Unlike conventional uniform timing control, the reading unit combines AI-based emotion estimation and timing control to greatly reduce the user's psychological burden, prevent erroneous operation and operation delays, and significantly improve the success rate, efficiency, and satisfaction of information tag reading. Technical effects include improved personalization of reading operations, optimization of user experience, reduction of cognitive load, enhancement of accessibility, and increased flexibility of system response. Application fields include instructions for home appliances and furniture, guidance in public facilities, tourist information provision, educational material presentation, medical device operation support, rehabilitation support, and stress care information provision. Furthermore, emotion estimation AI models and timing control algorithms can have various variations according to the application and user attributes, providing excellent system scalability and flexibility.

The reading unit can select the optimal reading method by considering the user's location information when reading the information tag. For example, when the user is indoors, the reading unit reads the information tag using Wi-Fi or Bluetooth. When the user is outdoors, the reading unit reads the information tag using GPS. When the user is moving, the reading unit reads the information tag using mobile data. Thus, the optimal reading method can be selected by considering the user's location information. Some or all of the above-described processing in the reading unit may be performed using AI or without using AI. For example, the reading unit may input the user's location information to the AI, and the AI can automatically select the optimal reading method. Specifically, the reading unit receives location information obtained from the user terminal (e.g., GPS coordinates, Wi-Fi access point ID, Bluetooth beacon ID, base station ID, movement determination by accelerometer values) as input. The reading unit inputs this location information to a location information classification model (e.g., LightGBM or SVM-based indoor/outdoor determination model) or a spatiotemporal data analysis AI (e.g., LSTM+CNN hybrid model). The AI model normalizes and extracts features from the input data and outputs location categories (e.g., “indoor,” “outdoor,” “moving”) and location scores (e.g., 0.95). Examples of input to the AI include: (1) GPS coordinates+Wi-Fi ID→“indoor” determination, (2) GPS coordinates only→“outdoor” determination, (3) large accelerometer value→“moving” determination. The AI output includes (1) “indoor”+“Wi-Fi/Bluetooth reading recommended,” (2) “outdoor”+“GPS/camera scan recommended,” (3) “moving”+“mobile data+simple UI recommended” as reading method instructions. The reading unit automatically switches the user interface layout and reading procedure (e.g., Wi-Fi/Bluetooth scan, GPS integration, camera activation, NFC tap) based on the AI output. In subsequent processing, the reading unit monitors location changes in real time and readjusts as necessary. Unlike conventional uniform reading methods, the reading unit combines AI-based location information analysis and interface control to greatly improve the success rate, efficiency, and user satisfaction of information tag reading optimized for the user's usage environment. Technical effects include improved location adaptability, efficiency of reading operations, optimization of user experience, enhancement of accessibility, and increased flexibility of system response. Application fields include instructions for home appliances and furniture, guidance in public facilities, tourist information provision, educational material presentation, medical device operation support, and information provision at outdoor/indoor events. Furthermore, location information analysis AI models and reading method selection algorithms can have various variations according to the application and device evolution, providing excellent system scalability and flexibility.

The reading unit can refer to the user's past reading history when reading the information tag and provide the optimal reading method. For example, the reading unit preferentially provides the reading method that the user has used in the past. The reading unit proposes the optimal reading method based on the user's past reading history. The reading unit analyzes the user's past reading history and provides the most efficient reading method. Thus, the optimal reading method can be provided by referring to the user's past reading history. Some or all of the above-described processing in the reading unit may be performed using AI or without using AI. For example, the reading unit may input the user's past reading history to the AI, and the AI can automatically provide the optimal reading method. Specifically, the reading unit receives past reading history data accumulated in the user terminal or server (e.g., date and time, tag type, reading method, success/failure flag, device type, environmental information, reading duration) as input. The reading unit inputs this history data to a time-series pattern analysis AI (e.g., LSTM or GRU-based recurrent neural network) or a user behavior clustering model (e.g., k-means or DBSCAN). The AI model extracts time-series features and performs clustering on the input data, and outputs the optimal reading method for each user (e.g., camera scan, NFC tap, Wi-Fi/Bluetooth scan) and recommended UI pattern. Examples of input to the AI include: (1) “Last 10 readings: camera scan success rate 90%”; (2) “Many failures in NFC tag reading”; (3) “High camera scan success rate outdoors”. The AI output includes (1) “Camera scan recommended,” (2) “NFC tap not recommended, Wi-Fi/Bluetooth scan recommended,” (3) “Camera scan recommended outdoors, Wi-Fi/Bluetooth scan recommended indoors” as reading method instructions. The reading unit automatically switches the user interface layout, guidance display, and reading procedure based on the AI output. In subsequent processing, the reading unit accumulates new reading history as needed and uses it to retrain the AI model and improve personalization accuracy. Unlike conventional uniform reading method presentation, the reading unit combines AI-based history analysis and personalization control to greatly improve the success rate, efficiency, and user satisfaction of information tag reading optimized for each user. Technical effects include improved history-based personalization, efficiency of reading operations, optimization of user experience, reduction of erroneous operation and failure rate, and increased flexibility of system response. Application fields include instructions for home appliances and furniture, guidance in public facilities, tourist information provision, educational material presentation, medical device operation support, rehabilitation support, and stress care information provision. Furthermore, history analysis AI models and reading method selection algorithms can have various variations according to the application and user attributes, providing excellent system scalability and flexibility.

The response generation unit can estimate the user's emotion and adjust the expression method of the response based on the estimated emotion of the user. For example, when the user is relaxed, the response generation unit generates a response in a friendly expression style. When the user is in a hurry, the response generation unit generates a response in a concise and clear expression style. When the user is excited, the response generation unit generates a response in a lively expression style. Thus, the expression method of the response can be adjusted based on the user's emotion. Emotion estimation is realized, for example, by using an emotion estimation function with an emotion engine or generative AI. The generative AI may be a text generation AI (such as an LLM) or a multimodal generation AI, but is not limited to these examples. Some or all of the above-described processing in the response generation unit may be performed using AI or without using AI. For example, the response generation unit may input the user's emotion data to the generative AI, and the generative AI can automatically adjust the expression method of the response. Specifically, the response generation unit receives emotion data obtained from the user terminal (e.g., spectral features of voice tone, facial landmark vectors from expression images, emotional vocabulary distribution in natural language text input, time-series data from biometric sensors such as heart rate or skin conductance) as input. The response generation unit inputs these diverse data to pre-trained emotion classification models such as BERT or RoBERTa, or multimodal emotion estimation models that handle voice, image, and biometric signals integratively (e.g., ResNet+LSTM hybrid models). The AI model performs preprocessing such as tokenization, normalization, and feature extraction (e.g., MFCC extraction, facial feature point extraction, time-series pattern extraction) on the input data and outputs emotion labels (e.g., “relaxed,” “in a hurry,” “excited”) and confidence scores (e.g., 0.91). Examples of input to the AI include: (1) text such as “Yay! The new home appliance has arrived!”, (2) a smiling facial image (128×128 pixel RGB tensor), (3) one minute of time-series data showing increased heart rate (sampling rate 1 Hz, 60-dimensional vector). The AI output includes (1) “excited” label and 0.93 confidence, (2) “relaxed” label and 0.88 confidence, (3) “in a hurry” label and 0.85 confidence. The response generation unit dynamically changes the parameters of the response generation algorithm (e.g., expression style, vocabulary selection, writing style template) according to the emotion label. For example, when “relaxed,” friendly vocabulary and polite writing style are automatically selected; when “in a hurry,” concise and clear imperative sentences are selected; when “excited,” lively writing style with frequent use of exclamation marks and emphasis is selected. AI models such as Transformer-based large language models or emotion-controllable response generation models (e.g., Conditional LLM) can be used. Examples of input to the AI include: (1) “relaxed” label+“how to use a microwave”→“I will explain slowly. How to use the microwave is . . . ”; (2) “in a hurry” label+“directions to the station”→“The shortest route is . . . ”; (3) “excited” label+“features of a new product”→“Amazing! The features of this new product are . . . ”. The AI output includes (1) friendly explanatory text, (2) concise instruction text, and (3) lively introduction text. In subsequent processing, the generated response is used as input to the provision unit, realizing personalization of the user experience. Unlike conventional uniform response generation, the response generation unit combines AI-based emotion estimation and expression control to automatically generate responses optimized for the user's psychological state and situation, greatly improving the personalization, satisfaction, and efficiency of information transmission in the user experience. Technical effects include improved flexibility and diversity of response generation, responsiveness to user requests, optimization of information presentation, and reduction of cognitive load. Application fields include instructions for home appliances and furniture, guidance in public facilities, tourist guides, educational material presentation, medical device operation instructions, rehabilitation support, and stress care information provision. Furthermore, emotion estimation AI models and response expression control algorithms can have various variations according to the application and user attributes, providing excellent system scalability and flexibility.

The response generation unit can adjust the level of detail of the response based on the importance of the read prompt. For example, the response generation unit generates a detailed response for a highly important prompt. The response generation unit generates a concise response for a less important prompt. The response generation unit generates a response with an appropriate level of detail for a prompt of medium importance. Thus, the level of detail of the response can be adjusted based on the importance of the read prompt. Some or all of the above-described processing in the response generation unit may be performed using generative AI or without using generative AI. For example, the response generation unit may input the importance data of the read prompt to the generative AI, and the generative AI can automatically adjust the level of detail of the response. Specifically, the response generation unit receives prompt information from the reading unit and importance scores assigned to each prompt (e.g., 0.95, 0.60, 0.30) as input. The response generation unit dynamically adjusts the detail parameters (e.g., length of explanation, number of elements, presence of specific examples, addition of supplementary information) of the response generation algorithm based on the importance scores. AI models such as Transformer-based large language models or importance-controllable response generation models (e.g., Conditional LLM) can be used. Examples of input to the AI include: (1) importance 0.95+“safety features of microwave”→“I will explain in detail about the safety features of this microwave . . . ”; (2) importance 0.60+“assembly procedure of furniture”→“The assembly procedure is as follows . . . ”; (3) importance 0.30+“usage time of map bulletin board”→“The usage time is from 8:00 to 20:00.”. The AI output includes (1) detailed explanatory text, (2) procedure text with appropriate detail, and (3) concise guidance text. In subsequent processing, the generated response is used as input to the provision unit. Unlike conventional uniform response generation, the response generation unit combines AI-based importance control and detail adjustment to automatically generate optimal responses according to the granularity and priority of information required by the user, greatly improving the efficiency of information transmission, user satisfaction, and reduction of cognitive load. Technical effects include optimization of response generation, enhanced personalization of information presentation, emphasis of important information, and prevention of information overload. Application fields include instructions for home appliances and furniture, guidance in public facilities, tourist guides, educational material presentation, medical device operation instructions, and factory equipment maintenance guidance. Furthermore, importance evaluation AI models and response detail control algorithms can have various variations according to the application and user attributes, providing excellent system scalability and flexibility.

The response generation unit can apply different response generation algorithms according to the category of the read prompt. For example, for home appliances, the response generation unit applies a response generation algorithm specialized for usage instructions. For furniture, the response generation unit applies a response generation algorithm specialized for maintenance instructions. For map bulletin boards, the response generation unit applies a response generation algorithm specialized for route guidance. Thus, different response generation algorithms can be applied according to the category of the read prompt. Some or all of the above-described processing in the response generation unit may be performed using generative AI or without using generative AI. For example, the response generation unit may input the category information of the read prompt to the generative AI, and the generative AI can automatically apply the response generation algorithm. Specifically, the response generation unit receives category labels of the prompt from the reading unit (e.g., “home appliances,” “furniture,” “map bulletin board,” “public facility”) and attribute vectors for each category (e.g., model number, function, usage scene for home appliances; material, assembly procedure for furniture; installation location, destination information for map bulletin boards) as input. The response generation unit automatically switches the response generation algorithm (e.g., rule-based templates, category-specialized LLMs, conditional generation models) according to the category label. AI models such as large language models fine-tuned for each category or two-stage models for category determination and response generation can be used. Examples of input to the AI include: (1) category “home appliances”+“defrost function”→“How to use the defrost function of this home appliance is . . . ”; (2) category “furniture”+“maintenance cycle”→“The maintenance method for this furniture is . . . ”; (3) category “map bulletin board”+“destination: station”→“The route from XX to the station is . . . ”. The AI output includes (1) usage instruction response, (2) maintenance procedure response, and (3) route guidance response. In subsequent processing, the generated response is used as input to the provision unit. Unlike conventional uniform response generation, the response generation unit combines AI-based category determination and algorithm switching to automatically generate responses optimized for the type and application of the object, greatly improving the accuracy, flexibility, and user satisfaction of information provision. Technical effects include diversity and optimization of response generation, category-specialized information provision, responsiveness to user requests, and improved efficiency of information transmission. Application fields include instructions for home appliances and furniture, guidance in public facilities, tourist guides, educational material presentation, medical device operation instructions, and factory equipment maintenance guidance. Furthermore, category determination AI models and response generation algorithms can have various variations according to the application and category characteristics, providing excellent system scalability and flexibility.

The response generation unit can estimate the user's emotion and adjust the length of the response based on the estimated emotion of the user. For example, when the user is in a hurry, the response generation unit generates a short response that focuses on the main points. When the user is relaxed, the response generation unit generates a longer response that includes detailed explanations. When the user is excited, the response generation unit generates a response with visually stimulating effects. Thus, the length of the response can be adjusted based on the user's emotion. Emotion estimation is realized, for example, by using an emotion estimation function with an emotion engine or generative AI. The generative AI may be a text generation AI (such as an LLM) or a multimodal generation AI, but is not limited to these examples. Some or all of the above-described processing in the response generation unit may be performed using AI or without using AI. For example, the response generation unit may input the user's emotion data to the generative AI, and the generative AI can automatically adjust the length of the response. Specifically, the response generation unit receives emotion data obtained from the user terminal (e.g., voice tone, facial expression image, emotional vocabulary in text input, biometric sensor time-series data) as input, and outputs emotion labels such as “in a hurry,” “relaxed,” or “excited,” along with confidence scores, using an emotion estimation AI (e.g., a BERT-based emotion classification model or a multimodal emotion estimation model). Examples of input to the AI include: (1) “in a hurry” label +“directions to the station”→“The shortest route is . . . ”; (2) “relaxed” label+“how to use home appliances”→“I will explain slowly. How to use the microwave is . . . ”; (3) “excited” label+“features of a new product”→“Amazing! The features of this new product are . . . ”. The AI output includes (1) a short response focusing on the main points, (2) a long response with detailed explanations, and (3) a response with visual effects (e.g., including emojis or emphasis). The response generation unit dynamically changes the length parameters (e.g., maximum token count, number of elements, presence of supplementary information) and expression style of the response generation algorithm according to the emotion label. In subsequent processing, the generated response is used as input to the provision unit. Unlike conventional uniform response generation, the response generation unit combines AI-based emotion estimation and length control to automatically generate responses optimized for the user's psychological state and situation, greatly improving the efficiency of information transmission, user satisfaction, and reduction of cognitive load. Technical effects include improved flexibility and diversity of response generation, responsiveness to user requests, optimization of information presentation, and reduction of cognitive load. Application fields include instructions for home appliances and furniture, guidance in public facilities, tourist guides, educational material presentation, medical device operation instructions, rehabilitation support, and stress care information provision. Furthermore, emotion estimation AI models and response length control algorithms can have various variations according to the application and user attributes, providing excellent system scalability and flexibility.

The response generation unit can determine the priority of the response based on the submission timing of the read prompt. For example, the response generation unit determines the priority of the response based on the latest prompt. The response generation unit may set a lower priority for responses based on older prompts. The response generation unit may set a medium priority for responses based on prompts with a medium submission timing. Thus, the priority of the response can be determined based on the submission timing of the read prompt. Some or all of the above-described processing in the response generation unit may be performed using generative AI or without using generative AI. For example, the response generation unit may input the submission timing data of the read prompt to the generative AI, and the generative AI can automatically determine the priority of the response. Specifically, the response generation unit receives prompt information from the reading unit and submission timing data assigned to each prompt (e.g., UNIX timestamps, date strings, elapsed days) as input. The response generation unit dynamically adjusts the priority parameters (e.g., priority score, display order, output timing) of the response generation algorithm based on the submission timing data. AI models such as priority inference models considering submission timing or time-series data analysis AI (e.g., LSTM-based time-series classification models) can be used. Examples of input to the AI include: (1) submission timing “2024 Jun. 1”+“new features of home appliances”→“Response generated with high priority as latest information”; (2) submission timing “2023 Jan. 1”+“old model of furniture”→“Response generated with low priority and deferred”; (3) submission timing “2024 Mar. 15”+“event information on map bulletin board”→“Response generated with medium priority”. The AI output includes (1) high-priority response, (2) low-priority response, and (3) medium-priority response. In subsequent processing, the generated response is used as input to the provision unit. Unlike conventional uniform response generation, the response generation unit combines AI-based submission timing analysis and priority control to automatically generate optimal responses according to the freshness and importance of information, greatly improving the immediacy of information transmission, user satisfaction, and the speed of reflecting information updates. Technical effects include improved immediacy and optimization of response generation, enhanced freshness of information presentation, rapid response to user requests, and immediate reflection of information updates. Application fields include instructions for home appliances and furniture, guidance in public facilities, tourist guides, educational material presentation, medical device operation instructions, and factory equipment maintenance guidance. Furthermore, submission timing analysis AI models and response priority control algorithms can have various variations according to the application and information characteristics, providing excellent system scalability and flexibility.

The response generation unit can adjust the order of the response based on the relevance of the read prompt. For example, the response generation unit generates responses by prioritizing highly relevant prompts. The response generation unit generates responses by deferring less relevant prompts. The response generation unit generates responses by appropriately placing prompts with medium relevance. Thus, the order of the response can be adjusted based on the relevance of the read prompt. Some or all of the above-described processing in the response generation unit may be performed using generative AI or without using generative AI. For example, the response generation unit may input relevance data of the read prompt to the generative AI, and the generative AI can automatically adjust the order of the response. Specifically, the response generation unit receives prompt information from the reading unit and relevance scores assigned to each prompt (e.g., 0.98, 0.65, 0.40) or relevance category labels (e.g., “home appliances-safety,” “furniture-maintenance,” “map-event”) as input. The response generation unit dynamically adjusts the order parameters (e.g., display order, output priority, grouping order) of the response generation algorithm based on the relevance scores. AI models such as relevance inference models (e.g., BERT-based semantic similarity models or knowledge graph inference models) or response generation models with relevance control can be used. Examples of input to the AI include: (1) relevance 0.98+“safety features of home appliances”→“Response generated with highest priority”; (2) relevance 0.65+“assembly procedure of furniture”→“Response generated with medium order”; (3) relevance 0.40+“usage time of map bulletin board”→“Response generated with lowest priority”. The AI output includes (1) high-relevance response, (2) medium-relevance response, and (3) low-relevance response. In subsequent processing, the generated response is used as input to the provision unit. Unlike conventional uniform response generation, the response generation unit combines AI-based relevance analysis and order control to automatically generate optimal responses according to the priority and context of information required by the user, greatly improving the efficiency of information transmission, user satisfaction, and reduction of cognitive load. Technical effects include optimization of response generation, enhanced personalization of information presentation, emphasis of relevant information, and prevention of information overload. Application fields include instructions for home appliances and furniture, guidance in public facilities, tourist guides, educational material presentation, medical device operation instructions, and factory equipment maintenance guidance. Furthermore, relevance evaluation AI models and response order control algorithms can have various variations according to the application and user attributes, providing excellent system scalability and flexibility.

The provision unit can estimate the user's emotion and adjust the method of providing the response based on the estimated emotion of the user. For example, when the user is relaxed, the provision unit provides the response in a friendly expression style. When the user is in a hurry, the provision unit provides the response in a concise and clear expression style. When the user is excited, the provision unit provides the response in a lively expression style. Thus, the method of providing the response can be adjusted based on the user's emotion. Emotion estimation is realized, for example, by using an emotion estimation function with an emotion engine or generative AI. The generative AI may be a text generation AI (such as an LLM) or a multimodal generation AI, but is not limited to these examples. Some or all of the above-described processing in the provision unit may be performed using AI or without using AI. For example, the provision unit may input the user's emotion data to the generative AI, and the generative AI can automatically adjust the method of providing the response. Specifically, the provision unit receives emotion data obtained from the user terminal (e.g., spectral features of voice tone, facial landmark vectors from expression images, emotional vocabulary distribution in natural language text input, time-series data from biometric sensors such as heart rate or skin conductance) as input. The provision unit inputs these diverse data to pre-trained emotion classification models such as BERT or RoBERTa, or multimodal emotion estimation models that handle voice, image, and biometric signals integratively (e.g., ResNet+LSTM hybrid models). The AI model performs preprocessing such as tokenization, normalization, and feature extraction (e.g., MFCC extraction, facial feature point extraction, time-series pattern extraction) on the input data and outputs emotion labels (e.g., “relaxed,” “in a hurry,” “excited”) and confidence scores (e.g., 0.91). Examples of input to the AI include: (1) text such as “Yay! The new home appliance has arrived!”, (2) a smiling facial image (128×128 pixel RGB tensor), (3) one minute of time-series data showing increased heart rate (sampling rate 1 Hz, 60-dimensional vector). The AI output includes (1) “excited” label and 0.93 confidence, (2) “relaxed” label and 0.88 confidence, (3) “in a hurry” label and 0.85 confidence. The provision unit dynamically changes the parameters of the response provision algorithm (e.g., expression style, vocabulary selection, output channel selection, UI layout, speech synthesis tone) according to the emotion label. For example, when “relaxed,” friendly vocabulary, polite writing style, and soft speech tone are automatically selected; when “in a hurry,” concise and clear imperative sentences, short text display, and immediate speech playback are selected; when “excited,” lively writing style with frequent use of exclamation marks and emphasis, animated UI, and bright color themes are selected. AI models such as Transformer-based large language models or emotion-controllable response provision models (e.g., Conditional LLM) can be used. Examples of input to the AI include: (1) “relaxed” label+“how to use a microwave”→“I will explain slowly. How to use the microwave is . . . ” provided via screen and voice; (2) “in a hurry” label+“directions to the station”→“The shortest route is . . . ” immediately displayed as text and map; (3) “excited” label+“features of a new product”→“Amazing! The features of this new product are . . . ” presented with animation. The AI output includes (1) friendly explanatory text+soft voice, (2) concise instruction text+emphasized display, (3) lively introduction text+UI with visual effects. In subsequent processing, the generated response is input to the multimodal output control module of the provision unit, and output channels such as screen display, speech synthesis, and haptic feedback are optimized according to the emotion label. Unlike conventional uniform response provision, the provision unit combines AI-based emotion estimation and multimodal output control to automatically realize response provision optimized for the user's psychological state and situation, greatly improving the personalization, satisfaction, and efficiency of information transmission in the user experience. Technical effects include improved flexibility and diversity of response provision, responsiveness to user requests, optimization of information presentation, reduction of cognitive load, and enhancement of accessibility. Application fields include instructions for home appliances and furniture, guidance in public facilities, tourist guides, educational material presentation, medical device operation instructions, rehabilitation support, and stress care information provision. Furthermore, emotion estimation AI models and response provision control algorithms can have various variations according to the application and user attributes, providing excellent system scalability and flexibility.

The provision unit can select the optimal provision method according to the type and performance of the user's device when providing the response. For example, when the user is using a smartphone, the provision unit provides a provision method adapted to the screen size. When the user is using a tablet, the provision unit provides a provision method optimized for a large screen. When the user is using a smartwatch, the provision unit provides a concise and highly visible provision method. Thus, the optimal provision method can be selected according to the type and performance of the user's device. Some or all of the above-described processing in the provision unit may be performed using AI or without using AI. For example, the provision unit may input the user's device information to the AI, and the AI can automatically select the optimal provision method. Specifically, the provision unit receives device information obtained from the user terminal (e.g., device type, screen resolution, CPU/GPU performance, OS version, camera performance, NFC support, battery level) as input. The provision unit inputs this device information to a device characteristic classification model (e.g., LightGBM or random forest-based device clustering model) or a rule-based provision method selection algorithm using device attribute vectors. The AI model normalizes and extracts features from the input data and outputs device categories (e.g., “smartphone,” “tablet,” “smartwatch”) and performance scores (e.g., high, medium, low). Examples of input to the AI include: (1) “Device type: smartphone, screen resolution: 1080×2400, NFC: yes”; (2) “Device type: tablet, screen resolution: 2560×1600, camera: high performance”; (3) “Device type: smartwatch, screen resolution: 320×320, battery: 80%”. The AI output includes (1) “Standard UI for smartphone+voice output recommended,” (2) “Enlarged UI for tablet+detailed guide display,” (3) “Simple UI for smartwatch+vibration notification recommended” as provision method instructions. The provision unit automatically switches the user interface layout, button size, guidance display, and response output procedure (e.g., text display, voice playback, vibration notification) based on the AI output. In subsequent processing, the provision unit dynamically optimizes the resolution and bit rate of image and voice data, UI element arrangement, and communication method (Wi-Fi/Bluetooth/mobile data) according to device performance. Unlike conventional uniform response provision UIs, the provision unit combines AI-based device characteristic analysis and interface control to achieve optimal operability, visibility, and power saving for each user device, greatly improving the success rate, efficiency, and user satisfaction of response provision. Technical effects include improved device adaptability, efficiency of response provision operations, optimization of user experience, enhancement of accessibility, and increased flexibility of system response. Application fields include instructions for home appliances and furniture, guidance in public facilities, tourist information provision, educational material presentation, medical device operation support, and wearable device integration. Furthermore, device characteristic classification AI models and provision method selection algorithms can have various variations according to the application and device evolution, providing excellent system scalability and flexibility.

The provision unit can refer to the user's past response history when providing the response and provide the optimal provision method. For example, the provision unit preferentially provides the provision method that the user has used in the past. The provision unit proposes the optimal provision method based on the user's past response history. The provision unit analyzes the user's past response history and provides the most efficient provision method. Thus, the optimal provision method can be provided by referring to the user's past response history. Some or all of the above-described processing in the provision unit may be performed using AI or without using AI. For example, the provision unit may input the user's past response history to the AI, and the AI can automatically provide the optimal provision method. Specifically, the provision unit receives past response history data accumulated in the user terminal or server (e.g., date and time, response type, provision method, success/failure flag, device type, environmental information, response duration) as input. The provision unit inputs this history data to a time-series pattern analysis AI (e.g., LSTM or GRU-based recurrent neural network) or a user behavior clustering model (e.g., k-means or DBSCAN). The AI model extracts time-series features and performs clustering on the input data, and outputs the optimal provision method for each user (e.g., text display, voice output, vibration notification, image presentation) and recommended UI pattern. Examples of input to the AI include: (1) “Last 10 responses: voice output success rate 90%”; (2) “Many failures in text display responses”; (3) “High voice output success rate outdoors”. The AI output includes (1) “Voice output recommended,” (2) “Text display not recommended, image presentation recommended,” (3) “Voice output recommended outdoors, text display recommended indoors” as provision method instructions. The provision unit automatically switches the user interface layout, guidance display, and response output procedure based on the AI output. In subsequent processing, the provision unit accumulates new response history as needed and uses it to retrain the AI model and improve personalization accuracy. Unlike conventional uniform response provision method presentation, the provision unit combines AI-based history analysis and personalization control to greatly improve the success rate, efficiency, and user satisfaction of response provision optimized for each user. Technical effects include improved history-based personalization, efficiency of response provision operations, optimization of user experience, reduction of erroneous operation and failure rate, and increased flexibility of system response. Application fields include instructions for home appliances and furniture, guidance in public facilities, tourist information provision, educational material presentation, medical device operation support, rehabilitation support, and stress care information provision. Furthermore, history analysis AI models and provision method selection algorithms can have various variations according to the application and user attributes, providing excellent system scalability and flexibility.

The provision unit can estimate the user's emotion and adjust the timing of providing the response based on the estimated emotion of the user. For example, when the user is nervous, the provision unit provides the response at a calm timing. When the user is relaxed, the provision unit provides the response at any timing. When the user is in a hurry, the provision unit provides the response quickly. Thus, the timing of providing the response can be adjusted based on the user's emotion. Emotion estimation is realized, for example, by using an emotion estimation function with an emotion engine or generative AI. The generative AI may be a text generation AI (such as an LLM) or a multimodal generation AI, but is not limited to these examples. Some or all of the above-described processing in the provision unit may be performed using AI or without using AI. For example, the provision unit may input the user's emotion data to the generative AI, and the generative AI can automatically adjust the timing of providing the response. Specifically, the provision unit receives emotion data obtained from the user terminal (e.g., spectral features of voice tone, facial landmark vectors from expression images, emotional vocabulary distribution in natural language text input, time-series data from biometric sensors such as heart rate or skin conductance) as input. The provision unit inputs these diverse data to pre-trained emotion classification models such as BERT or RoBERTa, or multimodal emotion estimation models that handle voice, image, and biometric signals integratively (e.g., ResNet+LSTM hybrid models). The AI model performs preprocessing such as tokenization, normalization, and feature extraction (e.g., MFCC extraction, facial feature point extraction, time-series pattern extraction) on the input data and outputs emotion labels (e.g., “nervous,” “relaxed,” “in a hurry”) and confidence scores (e.g., 0.91). Examples of input to the AI include: (1) text such as “I'm anxious because it's my first time operating this,” (2) a nervous facial expression image (128×128 pixel RGB tensor), (3) one minute of time-series data showing increased heart rate (sampling rate 1 Hz, 60-dimensional vector). The AI output includes (1) “nervous” label and 0.93 confidence, (2) “relaxed” label and 0.88 confidence, (3) “in a hurry” label and 0.85 confidence. The provision unit dynamically changes the timing control algorithm (e.g., timing window setting, user operation waiting time, guidance display timing, notification timing) according to the emotion label. For example, when “nervous,” relaxation guidance is displayed before prompting user operation, and the response is presented after waiting for a certain period. When “relaxed,” user operations are accepted immediately. When “in a hurry,” the response is presented immediately and guidance display is omitted. AI models may use rule-based engines or conditional generation models to select optimal timing control patterns by combining emotion labels and user operation history. In subsequent processing, the provision unit immediately switches the timing control and guidance display of the user interface according to the AI output, providing a response provision experience optimized for the user's psychological state. Unlike conventional uniform timing control, the provision unit combines AI-based emotion estimation and timing control to greatly reduce the user's psychological burden, prevent erroneous operation and operation delays, and significantly improve the success rate, efficiency, and satisfaction of response provision. Technical effects include improved personalization of response provision operations, optimization of user experience, reduction of cognitive load, enhancement of accessibility, and increased flexibility of system response. Application fields include instructions for home appliances and furniture, guidance in public facilities, tourist information provision, educational material presentation, medical device operation support, rehabilitation support, and stress care information provision. Furthermore, emotion estimation AI models and timing control algorithms can have various variations according to the application and user attributes, providing excellent system scalability and flexibility.

The provision unit can select the optimal provision method by considering the user's location information when providing the response. For example, when the user is indoors, the provision unit provides the response using Wi-Fi or Bluetooth. When the user is outdoors, the provision unit provides the response using GPS. When the user is moving, the provision unit provides the response using mobile data. Thus, the optimal provision method can be selected by considering the user's location information. Some or all of the above-described processing in the provision unit may be performed using AI or without using AI. For example, the provision unit may input the user's location information to the AI, and the AI can automatically select the optimal provision method. Specifically, the provision unit receives location information obtained from the user terminal (e.g., GPS coordinates, Wi-Fi access point ID, Bluetooth beacon ID, base station ID, movement determination by accelerometer values) as input. The provision unit inputs this location information to a location information classification model (e.g., LightGBM or SVM-based indoor/outdoor determination model) or a spatiotemporal data analysis AI (e.g., LSTM+CNN hybrid model). The AI model normalizes and extracts features from the input data and outputs location categories (e.g., “indoor,” “outdoor,” “moving”) and location scores (e.g., 0.95). Examples of input to the AI include: (1) GPS coordinates+Wi-Fi ID→“indoor” determination, (2) GPS coordinates only→“outdoor” determination, (3) large accelerometer value→“moving” determination. The AI output includes (1) “indoor”+“Wi-Fi/Bluetooth response recommended,” (2) “outdoor”+“GPS/mobile data response recommended,” (3) “moving”+“mobile data+simple UI response recommended” as provision method instructions. The provision unit automatically switches the user interface layout and response output procedure (e.g., Wi-Fi/Bluetooth communication, GPS integration, mobile data communication, UI simplification) based on the AI output. In subsequent processing, the provision unit monitors location changes in real time and readjusts as necessary. Unlike conventional uniform response provision methods, the provision unit combines AI-based location information analysis and interface control to greatly improve the success rate, efficiency, and user satisfaction of response provision optimized for the user's usage environment. Technical effects include improved location adaptability, efficiency of response provision operations, optimization of user experience, enhancement of accessibility, and increased flexibility of system response. Application fields include instructions for home appliances and furniture, guidance in public facilities, tourist information provision, educational material presentation, medical device operation support, and information provision at outdoor/indoor events. Furthermore, location information analysis AI models and provision method selection algorithms can have various variations according to the application and device evolution, providing excellent system scalability and flexibility.

The provision unit can analyze the user's social media activity when providing a response and propose an optimal provision method. For example, the provision unit analyzes the user's social media activity and provides information that is likely to be of interest. The provision unit may propose an optimal provision method based on the user's social media activity. Furthermore, the provision unit may provide the most efficient provision method based on the user's social media activity. Thus, by analyzing the user's social media activity, the provision unit can propose an optimal provision method. Some or all of the above-described processing in the provision unit may be performed using AI, or may be performed without using AI. For example, the provision unit may input the user's social media activity data into AI, and the AI can automatically propose an optimal provision method. Specifically, the provision unit receives as input social media activity data obtained from the user terminal or server (e.g., text of posts, images, videos, posting frequency, like/share history, follow relationships, hashtag distribution, time series data of posting times, etc.). The provision unit inputs these diverse data into natural language processing AI (e.g., BERT-based interest estimation model), image recognition AI (e.g., ResNet or EfficientNet), and time series analysis AI (e.g., LSTM or Transformer-based behavior prediction model). The AI models perform preprocessing such as tokenization, feature extraction, clustering, and semantic analysis on the input data, and output interest categories (e.g., “home appliances,” “furniture,” “tourism,” “health”), interest scores (e.g., 0.92), and recommended provision methods (e.g., image-centric, video-centric, text-centric, audio-centric). Examples of AI input include: (1) “Many posts reviewing home appliances”→“Recommend image +text response related to home appliances”; (2) “Many posts of tourist spot photos”→“Recommend image+map response for tourism information”; (3) “Frequent use of health-related hashtags”→“Recommend text+audio response for health information.” AI output examples include: (1) “Recommend home appliance images+text response”; (2) “Recommend tourist spot images+map response”; (3) “Recommend health information text+audio response.” Based on the AI output, the provision unit automatically switches the layout of the user interface and response output procedures (e.g., image display, video playback, speech synthesis, text display, etc.). In subsequent processing, the provision unit continuously accumulates new social media activity data and utilizes it for retraining the AI models and improving personalization accuracy. Unlike conventional uniform response provision methods, the provision unit combines AI-based social media analysis and personalization control to greatly improve the success rate, efficiency, and user satisfaction of response provision optimized for each user. Technical effects include improved personalization based on interests, increased efficiency of response provision operations, optimized user experience, optimized information transmission, and enhanced flexibility of system responses. Application fields include integration with home appliance and furniture instruction manuals, guidance for public facilities, provision of tourist information, presentation of teaching materials in educational settings, support for operation of medical devices, rehabilitation support, provision of stress care information, and more. Furthermore, the social media analysis AI models and provision method selection algorithms can be diversified according to use cases and user attributes, providing excellent system scalability and flexibility.

The system according to the embodiment is not limited to the examples described above and can be variously modified, for example, as follows. Specifically, the system may adopt an architecture that assumes modular design of each component and API integration, allowing flexible changes to the types of AI models, data flow, input/output interfaces, control algorithms, learning methods, hardware configuration, and more. For example, the system may implement each functional block, such as the generation unit, reading unit, response generation unit, provision unit, and collection unit, as independent microservices and deploy them in a distributed computing environment on the cloud or in a local inference environment on edge devices. The system can select and combine AI models such as Transformer-based large language models, convolutional neural networks, recurrent neural networks, graph neural networks, decision tree models, and rule-based engines according to the application and data characteristics. The system can process input data from user terminals (e.g., image tensors, audio waveforms, text vectors, biosensor time series data, location information vectors, device attribute vectors, behavior history arrays, etc.) using various preprocessing pipelines (e.g., normalization, feature extraction, data augmentation, noise removal, tokenization, clustering, etc.) and use them as input to AI models. The system can obtain output from AI models such as score vectors, label arrays, probability distributions, structured text, generated image data, synthesized audio data, UI control parameters, and link them to subsequent control modules or user interfaces. The system can continuously improve model accuracy, generalization, and personalization by applying learning methods such as supervised learning, self-supervised learning, transfer learning, online learning, reinforcement learning, and federated learning as appropriate. The system can cooperate with external systems such as databases, cache servers, message queues, and real-time streaming platforms to efficiently manage, transmit, and reuse large-scale data. Technical effects include easy expansion, replacement, and version upgrades of components, rapid adaptation to changes in application and operating environments, optimization and improved personalization accuracy of AI models, and significant improvements in overall system processing efficiency, response speed, reliability, and maintainability. Application fields include instruction manuals for home appliances and furniture, guidance for public facilities, tourist guides, presentation of teaching materials in educational settings, operation instructions for medical devices, maintenance guidance for factory equipment, rehabilitation support, provision of stress care information, smart home control, IoT device integration, industrial robot control, disaster information provision, and many other fields. Furthermore, the system has scalability and future potential to flexibly respond to future technological advances and social demands, such as adding variations of AI models and algorithms, diversifying data sources, customizing for user attributes and usage scenarios, and strengthening security and privacy controls.

The collection unit can analyze the user's past behavior history and preferentially collect information that the user has previously shown interest in. For example, if the user has frequently searched for information on how to use home appliances in the past, the collection unit preferentially collects the latest usage and maintenance information regarding home appliances. If the user is interested in a specific furniture brand, the collection unit can collect new product information and maintenance information about that brand. Furthermore, if the user frequently uses map bulletin boards for a specific region, the collection unit can collect the latest traffic and event information for that region. In this way, more personalized information can be provided based on the user's past behavior history. Specifically, the collection unit receives as input behavior history data accumulated in the user terminal or server (e.g., time series arrays of search queries, click logs, tag reading history, location information vectors, device type, usage time zone, success/failure flags, etc.). The collection unit inputs these history data into time series pattern analysis AI (e.g., LSTM or GRU-based recurrent neural networks), user behavior clustering models (e.g., k-means or DBSCAN), and interest estimation models (e.g., BERT-based category classification models). The AI models perform preprocessing such as time series feature extraction, clustering, and semantic analysis on the input data, and output interest categories for each user (e.g., “home appliances,” “furniture,” “map bulletin boards”), interest scores (e.g., 0.92), and recommended information types (e.g., new product information, maintenance information, event information, etc.). Examples of AI input include: (1) “Frequent search history for home appliance usage”→“Prioritize collection of latest usage and maintenance information for home appliances”; (2) “Frequent browsing history for a specific furniture brand”→“Prioritize collection of new product and maintenance information for that brand”; (3) “High frequency of use of map bulletin boards for a specific region”→“Prioritize collection of traffic and event information for that region.” AI output examples include: (1) instruction to collect home appliance-related information, (2) instruction to collect furniture brand information, (3) instruction to collect regional event information. Based on the AI output, the collection unit controls information collection APIs, web crawlers, IoT device integration modules, etc., to collect information with assigned priorities. In subsequent processing, the collected information is used as input to the generation unit and response generation unit, enabling optimized information provision for each user. Unlike conventional uniform information collection, the collection unit combines AI-based history analysis and personalization control to automate information collection that responds to the user's interests, preferences, and usage tendencies, greatly improving the accuracy, efficiency, and user satisfaction of information provision. Technical effects include improved personalization based on history, increased efficiency of information collection, optimization of information freshness and relevance, improved user experience, and enhanced flexibility of system responses. Application fields include integration with home appliance and furniture instruction manuals, guidance for public facilities, provision of tourist information, presentation of teaching materials in educational settings, support for operation of medical devices, rehabilitation support, provision of stress care information, and more. Furthermore, history analysis AI models and information collection control algorithms can be diversified according to use cases and user attributes, providing excellent system scalability and flexibility.

The generation unit can generate prompts based on the user's current context. For example, if the user reads an information tag while using a home appliance, the generation unit generates a prompt regarding how to use the home appliance or troubleshooting. If the user reads an information tag while assembling furniture, the generation unit generates a prompt regarding assembly procedures or required tools. Furthermore, if the user reads an information tag while using a public facility, the generation unit can generate a prompt regarding how to use the facility or precautions. In this way, appropriate information can be provided according to the user's current situation. Specifically, the generation unit receives as input context data obtained from the user terminal or sensors (e.g., current time, location information vector, device type, application ID in use, operation history, surrounding environment data, tag type, user attribute vector, etc.). The generation unit inputs these diverse context data into context classification AI (e.g., LightGBM or SVM-based situation judgment models), spatiotemporal data analysis AI (e.g., LSTM+CNN hybrid models), and conditional prompt generation models (e.g., category-specialized large language models). The AI models perform preprocessing such as normalization, feature extraction, clustering, and semantic analysis on the input data, and output usage scene categories (e.g., “using home appliances,” “assembling furniture,” “using public facilities”), recommended prompt types (e.g., usage instructions, troubleshooting, assembly procedures, tool guidance, facility usage instructions, precautions, etc.), and prompt text (e.g., “Tell me how to use this appliance,” “What tools are needed for assembly?”, “What are the precautions when using the facility?”). Examples of AI input include: (1) “Using home appliances”+“Tag type: microwave oven”→“Generate prompt for microwave oven usage and troubleshooting”; (2) “Assembling furniture”+“Tag type: table”→“Generate prompt for assembly procedure and tool guidance”; (3) “Using public facilities”+“Tag type: library”→“Generate prompt for usage instructions and precautions.” AI output examples include: (1) usage instruction prompt, (2) assembly procedure prompt, (3) facility usage guidance prompt. Based on the AI output, the generation unit dynamically adjusts template selection, expression style, and length parameters of the prompt generation algorithm. In subsequent processing, the generated prompt is encoded into the information tag or used as input to the response generation unit. Unlike conventional uniform prompt generation, the generation unit combines AI-based context analysis and prompt generation control to automatically generate prompts optimized for the user's current situation and usage scene, greatly improving the accuracy, flexibility, and user satisfaction of information provision. Technical effects include diversity and optimization of prompt generation, context-specialized information provision, responsiveness to user requests, and improved efficiency of information transmission. Application fields include instruction manuals for home appliances and furniture, guidance for public facilities, tourist guides, presentation of teaching materials in educational settings, operation instructions for medical devices, maintenance guidance for factory equipment, and more. Furthermore, context analysis AI models and prompt generation algorithms can be diversified according to use cases and usage scene characteristics, providing excellent system scalability and flexibility.

The reading unit can adjust the method of reading information tags according to the battery level of the user's device. For example, when the battery level is low, the reading unit provides an energy-efficient reading method. When the battery level is sufficient, the reading unit provides a high-precision reading method. When the battery level is moderate, the reading unit can provide a balanced reading method. In this way, the optimal reading method can be selected according to the battery status of the user's device. Specifically, the reading unit receives as input battery level data obtained from the user terminal (e.g., battery percentage, voltage value, current consumption, charging status, battery degradation level, etc.). The reading unit inputs this battery information into a battery status classification model (e.g., LightGBM or SVM-based battery level clustering model) and a reading method selection algorithm (e.g., rule-based engine, conditional generation model). The AI models perform normalization and feature extraction on the input data and output battery status categories (e.g., “low,” “medium,” “high”) and recommended reading methods (e.g., low power consumption mode, high precision mode, balanced mode). Examples of AI input include: (1) battery level 10%→“Recommend low power consumption reading method”; (2) battery level 80%→“Recommend high precision reading method”; (3) battery level 50%→“Recommend balanced mode reading method.” AI output examples include: (1) instructions for reduced camera resolution, frame rate limitation, NFC priority, etc. for power saving; (2) instructions for high-resolution camera scanning, multiple readings, enhanced noise reduction, etc. for high precision; (3) standard settings for balanced instructions. Based on the AI output, the reading unit dynamically optimizes the operation modes of the camera, NFC, Bluetooth, and UI display content using the hardware control API of the terminal. In subsequent processing, the reading unit monitors changes in battery level in real time and readjusts as necessary. Unlike conventional fixed reading settings, the reading unit combines AI-based battery status analysis and hardware control to greatly improve the success rate, efficiency, and user satisfaction of information tag reading under any battery condition. Technical effects include improved battery adaptability, optimization of reading accuracy and power saving, improved user experience, reduced misrecognition and failure rates, and enhanced flexibility of system responses. Application fields include integration with home appliance and furniture instruction manuals, guidance for public facilities, provision of tourist information, presentation of teaching materials in educational settings, support for operation of medical devices, information provision at outdoor/indoor events, and integration with wearable devices. Furthermore, battery status classification AI models and reading method selection algorithms can be diversified according to use cases and device evolution, providing excellent system scalability and flexibility.

The response generation unit can refer to the user's past question history and generate responses to similar questions. For example, if the user has previously asked about a specific function of a home appliance, the response generation unit generates a new response by referring to past responses to that question. If the user has previously asked about furniture maintenance methods, the response generation unit generates new maintenance information by referring to past responses to that question. Furthermore, if the user has previously asked about how to use a map bulletin board, the response generation unit can provide new route guidance information by referring to past responses to that question. In this way, more appropriate responses can be provided based on the user's past question history. Specifically, the response generation unit receives as input past question history data accumulated in the user terminal or server (e.g., question text arrays, question date and time, category labels, response content, success/failure flags, device type, usage scene, etc.). The response generation unit inputs these history data into natural language processing AI (e.g., BERT-based semantic similarity model), time series pattern analysis AI (e.g., LSTM or Transformer-based history matching model), and response generation models (e.g., conditional large language models). The AI models perform preprocessing such as tokenization, feature extraction, semantic analysis, and clustering on the input data, and output extraction of similar question pairs, selection of past response reuse candidates, new response generation parameters (e.g., expression style, level of detail, presence/absence of supplementary information), and response text (e.g., “How to use the defrost function of this appliance . . . ”, “How to maintain this furniture . . . ”, “Directions from XX to the station . . . ”). Examples of AI input include: (1) “Past question about the defrost function of a microwave oven”→“Generate new response for defrost procedure by referring to past responses”; (2) “Question history about furniture maintenance methods”→“Generate new maintenance information by referring to past responses”; (3) “Question history about how to use map bulletin boards”→“Generate new route guidance information by referring to past responses.” AI output examples include: (1) reuse of past responses and new responses with supplementary information; (2) responses using templates for similar questions; (3) history-based personalized responses. Based on the AI output, the response generation unit dynamically adjusts template selection, expression style, and level of detail parameters of the response generation algorithm. In subsequent processing, the generated response is used as input to the provision unit. Unlike conventional uniform response generation, the response generation unit combines AI-based history analysis and response generation control to automatically generate responses optimized for the user's past question tendencies and usage history, greatly improving the accuracy, efficiency, and user satisfaction of information transmission. Technical effects include improved personalization based on history, increased efficiency of response generation, optimization of information presentation, improved user experience, and enhanced flexibility of system responses. Application fields include instruction manuals for home appliances and furniture, guidance for public facilities, tourist guides, presentation of teaching materials in educational settings, operation instructions for medical devices, rehabilitation support, provision of stress care information, and more. Furthermore, history analysis AI models and response generation algorithms can be diversified according to use cases and user attributes, providing excellent system scalability and flexibility.

The provision unit can adjust the method of providing responses according to the network connection status of the user's device. For example, when the network connection is unstable, the provision unit prioritizes providing responses in text format. When the network connection is stable, the provision unit provides rich responses including audio and images. When the network connection is moderate, the provision unit can provide responses combining text and simple images. In this way, optimal responses can be provided according to the network connection status of the user's device. Specifically, the provision unit receives as input network connection information obtained from the user terminal (e.g., communication method (Wi-Fi/4G/5G), communication speed, packet loss rate, RTT, connection stability score, presence/absence of communication restrictions, buffer remaining, etc.). The provision unit inputs this network information into a network status classification model (e.g., LightGBM or SVM-based connection stability clustering model) and a provision method selection algorithm (e.g., rule-based engine, conditional generation model). The AI models perform normalization and feature extraction on the input data and output network status categories (e.g., “unstable,” “moderate,” “stable”) and recommended provision methods (e.g., text only, text+simple images, rich responses including audio, images, and video). Examples of AI input include: (1) communication speed 0.5 Mbps, packet loss rate 10%→“Recommend text response”; (2) communication speed 5 Mbps, packet loss rate 2%→“Recommend rich response including audio and images”; (3) communication speed 2 Mbps, packet loss rate 5%→“Recommend text+simple image response.” AI output examples include: (1) text-only response; (2) response including audio, images, and video; (3) text+simple image response. Based on the AI output, the provision unit automatically switches the layout of the user interface and response output procedures (e.g., image resolution, audio bitrate, video compression rate, etc.). In subsequent processing, the provision unit monitors changes in network status in real time and readjusts as necessary. Unlike conventional uniform response provision methods, the provision unit combines AI-based network status analysis and interface control to greatly improve the success rate, efficiency, and user satisfaction of response provision under any communication environment. Technical effects include improved network adaptability, increased efficiency of response provision operations, optimized user experience, optimized communication costs, and enhanced flexibility of system responses. Application fields include integration with home appliance and furniture instruction manuals, guidance for public facilities, provision of tourist information, presentation of teaching materials in educational settings, support for operation of medical devices, integration with wearable devices, and more. Furthermore, network status classification AI models and provision method selection algorithms can be diversified according to use cases and communication infrastructure evolution, providing excellent system scalability and flexibility.

The collection unit can estimate the user's emotion and adjust the type of information to be collected based on the estimated emotion. For example, when the user is excited, the collection unit prioritizes collecting information related to entertainment or hobbies. When the user is tired, the collection unit prioritizes collecting information related to relaxation or health. When the user is relaxed, the collection unit can prioritize collecting information related to education or learning. In this way, appropriate information can be provided according to the user's emotion. Specifically, the collection unit receives as input emotion data obtained from the user terminal (e.g., spectral features of voice tone, facial landmark vectors from facial images, emotional vocabulary distribution from natural language text input, time series data from biosensors such as heart rate and skin conductance). The collection unit inputs these diverse input data into pre-trained emotion classification models such as BERT or RoBERTa, and multimodal emotion estimation models that handle voice, image, and biosignals integratively (e.g., ResNet+LSTM hybrid models). The AI models perform preprocessing such as tokenization, normalization, and feature extraction (e.g., MFCC extraction, facial feature point extraction, time series pattern extraction) on the input data, and output emotion labels (e.g., “excited,” “fatigued,” “relaxed”) and confidence scores (e.g., 0.91). Examples of AI input include: (1) text such as “I'm excited!”; (2) smiling facial image (128×128 pixel RGB tensor); (3) one-minute time series data showing increased heart rate (sampling rate 1 Hz, 60-dimensional vector). AI output examples include: (1) “excited” label with 0.93 confidence; (2) “fatigued” label with 0.88 confidence; (3) “relaxed” label with 0.85 confidence. Based on the emotion label, the collection unit dynamically changes the category selection parameters of the information collection algorithm (e.g., prioritize entertainment, prioritize health information, prioritize educational information, etc.). In subsequent processing, the collected information is used as input to the generation unit and response generation unit. Unlike conventional uniform information collection, the collection unit combines AI-based emotion estimation and information type control to automate information collection optimized for the user's psychological state and situation, greatly improving the accuracy, flexibility, and user satisfaction of information provision. Technical effects include improved flexibility and diversity of information collection, responsiveness to user requests, optimization of information presentation, and reduction of cognitive load. Application fields include integration with home appliance and furniture instruction manuals, guidance for public facilities, provision of tourist information, presentation of teaching materials in educational settings, support for operation of medical devices, rehabilitation support, provision of stress care information, and more. Furthermore, emotion estimation AI models and information collection control algorithms can be diversified according to use cases and user attributes, providing excellent system scalability and flexibility.

The generation unit can estimate the user's emotion and adjust the tone of the prompt based on the estimated emotion. For example, when the user is relaxed, the generation unit generates prompts in a friendly tone. When the user is in a hurry, the generation unit generates prompts in a concise and clear tone. When the user is excited, the generation unit can generate prompts in a lively tone. In this way, prompts can be provided in an appropriate tone according to the user's emotion. Specifically, the generation unit receives as input emotion data obtained from the user terminal (e.g., voice tone, facial images, emotional vocabulary in text input, biosensor time series data), and outputs emotion labels such as “relaxed,” “in a hurry,” “excited,” and confidence scores using emotion estimation AI (e.g., BERT-based emotion classification models or multimodal emotion estimation models). Examples of AI input include: (1) “relaxed” label+“how to use home appliances”→“generate prompt in a friendly tone”; (2) “in a hurry” label+“directions to the station”→“generate prompt in a concise and clear tone”; (3) “excited” label+“features of new products”→“generate prompt in a lively tone.” AI output examples include: (1) friendly explanatory prompt; (2) concise instruction prompt; (3) lively introduction prompt. Based on the emotion label, the generation unit dynamically changes the tone parameters of the prompt generation algorithm (e.g., vocabulary selection, style template, presence/absence of emphasis expressions, etc.). In subsequent processing, the generated prompt is encoded into the information tag or used as input to the response generation unit. Unlike conventional uniform prompt generation, the generation unit combines AI-based emotion estimation and tone control to automatically generate prompts optimized for the user's psychological state and situation, greatly improving the efficiency of information transmission, user satisfaction, and reduction of cognitive load. Technical effects include improved flexibility and diversity of prompt generation, responsiveness to user requests, optimization of information presentation, and reduction of cognitive load. Application fields include instruction manuals for home appliances and furniture, guidance for public facilities, tourist guides, presentation of teaching materials in educational settings, operation instructions for medical devices, rehabilitation support, provision of stress care information, and more. Furthermore, emotion estimation AI models and prompt tone control algorithms can be diversified according to use cases and user attributes, providing excellent system scalability and flexibility.

The reading unit can estimate the user's emotion and adjust the information tag reading interface based on the estimated emotion. For example, when the user is nervous, the reading unit provides a simple and highly visible interface. When the user is relaxed, the reading unit provides an interface with detailed information. When the user is in a hurry, the reading unit can provide an interface that focuses on key points. In this way, the optimal reading interface can be provided according to the user's emotion. Specifically, the reading unit receives as input emotion data obtained from the user terminal (e.g., spectral features of voice tone, facial landmark vectors from facial images, emotional vocabulary distribution from natural language text input, time series data from biosensors such as heart rate and skin conductance). The reading unit inputs these diverse input data into pre-trained emotion classification models such as BERT or RoBERTa, and multimodal emotion estimation models that handle voice, image, and biosignals integratively (e.g., ResNet+LSTM hybrid models). The AI models perform preprocessing such as tokenization, normalization, and feature extraction (e.g., MFCC extraction, facial feature point extraction, time series pattern extraction) on the input data, and output emotion labels (e.g., “nervous,” “relaxed,” “in a hurry”) and confidence scores (e.g., 0.91). Examples of AI input include: (1) text such as “I'm anxious about my first operation”; (2) nervous facial image (128×128 pixel RGB tensor); (3) one-minute time series data showing increased heart rate (sampling rate 1 Hz, 60-dimensional vector). AI output examples include: (1) “nervous” label with 0.93 confidence; (2) “relaxed” label with 0.88 confidence; (3) “in a hurry” label with 0.85 confidence. Based on the emotion label, the reading unit dynamically changes the reading interface control algorithm (e.g., UI layout selection, font size, color emphasis, presence/absence of animation, length of explanatory text, etc.). For example, when “nervous,” only large buttons and clear guides are displayed, and a confirmation dialog is added to prevent erroneous operations. When “relaxed,” detailed explanations, hints, and supplementary information are displayed. When “in a hurry,” only the minimum steps and key points are emphasized. As AI models, rule-based engines or conditional generation models can be used to select the optimal UI/UX pattern by combining emotion labels and reading conditions (e.g., tag type, device type, ambient light, etc.). AI output examples include: (1) “nervous”+“QR code”→“Display only a large scan button and one-step guide”; (2) “relaxed”+“NFC tag”→“Display detailed reading procedure and hints”; (3) “in a hurry”+“barcode”→“Display immediate scan and key points only.” In subsequent processing, the reading unit immediately switches the layout and guidance content of the user interface according to the AI output, providing an operation experience optimized for the user's psychological state. Unlike conventional uniform reading UIs, the reading unit combines AI-based emotion estimation and interface control to reduce the user's psychological burden, prevent erroneous operations and operation delays, and greatly improve the success rate, efficiency, and satisfaction of information tag reading. Technical effects include improved personalization of reading operations, optimized user experience, reduced cognitive load, enhanced accessibility, and improved flexibility of system responses. Application fields include integration with home appliance and furniture instruction manuals, guidance for public facilities, provision of tourist information, presentation of teaching materials in educational settings, support for operation of medical devices, rehabilitation support, provision of stress care information, and more. Furthermore, emotion estimation AI models and reading interface control algorithms can be diversified according to use cases and user attributes, providing excellent system scalability and flexibility.

The response generation unit can estimate the user's emotion and adjust the content of the response based on the estimated emotion. For example, when the user is relaxed, the response generation unit provides detailed and comprehensive information. When the user is in a hurry, the response generation unit provides concise and focused information. When the user is excited, the response generation unit can provide visually appealing information. In this way, optimal response content can be provided according to the user's emotion. Specifically, the response generation unit receives as input emotion data obtained from the user terminal (e.g., spectral features of voice tone, facial landmark vectors from facial images, emotional vocabulary distribution from natural language text input, time series data from biosensors such as heart rate and skin conductance). The response generation unit inputs these diverse input data into pre-trained emotion classification models such as BERT or RoBERTa, and multimodal emotion estimation models that handle voice, image, and biosignals integratively (e.g., ResNet+LSTM hybrid models). The AI models perform preprocessing such as tokenization, normalization, and feature extraction (e.g., MFCC extraction, facial feature point extraction, time series pattern extraction) on the input data, and output emotion labels (e.g., “relaxed,” “in a hurry,” “excited”) and confidence scores (e.g., 0.91). Examples of AI input include: (1) “relaxed” label+“how to use home appliances”→“generate detailed and comprehensive response”; (2) “in a hurry” label+“directions to the station”→“generate concise response”; (3) “excited” label+“features of new products”→“generate visually appealing response.” AI output examples include: (1) detailed explanatory text; (2) concise instruction text; (3) response with visual effects (e.g., including emojis or emphasis expressions). Based on the emotion label, the response generation unit dynamically changes the content parameters of the response generation algorithm (e.g., length of explanatory text, number of elements, presence/absence of specific examples, addition of supplementary information, presence/absence of visual effects, etc.). In subsequent processing, the generated response is used as input to the provision unit. Unlike conventional uniform response generation, the response generation unit combines AI-based emotion estimation and content control to automatically generate responses optimized for the user's psychological state and situation, greatly improving the efficiency of information transmission, user satisfaction, and reduction of cognitive load. Technical effects include improved flexibility and diversity of response generation, responsiveness to user requests, optimization of information presentation, and reduction of cognitive load. Application fields include instruction manuals for home appliances and furniture, guidance for public facilities, tourist guides, presentation of teaching materials in educational settings, operation instructions for medical devices, rehabilitation support, provision of stress care information, and more. Furthermore, emotion estimation AI models and response content control algorithms can be diversified according to use cases and user attributes, providing excellent system scalability and flexibility.

The provision unit can estimate the user's emotion and adjust the format of response provision based on the estimated emotion. For example, when the user is relaxed, the provision unit provides responses in a friendly manner. When the user is in a hurry, the provision unit provides responses in a concise and clear manner. When the user is excited, the provision unit can provide responses in a lively manner. In this way, optimal response formats can be provided according to the user's emotion. Specifically, the provision unit receives as input emotion data obtained from the user terminal (e.g., spectral features of voice tone, facial landmark vectors from facial images, emotional vocabulary distribution from natural language text input, time series data from biosensors such as heart rate and skin conductance). The provision unit inputs these diverse input data into pre-trained emotion classification models such as BERT or RoBERTa, and multimodal emotion estimation models that handle voice, image, and biosignals integratively (e.g., ResNet+LSTM hybrid models). The AI models perform preprocessing such as tokenization, normalization, and feature extraction (e.g., MFCC extraction, facial feature point extraction, time series pattern extraction) on the input data, and output emotion labels (e.g., “relaxed,” “in a hurry,” “excited”) and confidence scores (e.g., 0.91). Examples of AI input include: (1) “relaxed” label+“how to use home appliances”→“provide response in a friendly manner”; (2) “in a hurry” label+“directions to the station”→“provide response in a concise and clear manner”; (3) “excited” label+“features of new products”→“provide response in a lively manner.” AI output examples include: (1) friendly explanatory text; (2) concise instruction text; (3) lively introduction text. Based on the emotion label, the provision unit dynamically changes the expression parameters of the response provision algorithm (e.g., vocabulary selection, style template, presence/absence of emphasis expressions, speech synthesis tone, UI layout, etc.). In subsequent processing, the generated response is optimized for output channels such as screen display, speech synthesis, and haptic feedback. Unlike conventional uniform response provision, the provision unit combines AI-based emotion estimation and expression control to automatically realize response provision optimized for the user's psychological state and situation, greatly improving the personalization, satisfaction, and efficiency of information transmission in the user experience. Technical effects include improved flexibility and diversity of response provision, responsiveness to user requests, optimization of information presentation, reduction of cognitive load, and enhanced accessibility. Application fields include instruction manuals for home appliances and furniture, guidance for public facilities, tourist guides, presentation of teaching materials in educational settings, operation instructions for medical devices, rehabilitation support, provision of stress care information, and more. Furthermore, emotion estimation AI models and response provision control algorithms can be diversified according to use cases and user attributes, providing excellent system scalability and flexibility.

The following is a brief description of the processing flow of Example of the Embodiment. Specifically, the system has a configuration in which multiple functional blocks such as the collection unit, generation unit, reading unit, response generation unit, and provision unit operate in cooperation. The system exchanges information vectors, prompt data, tag information, user attribute vectors, emotion labels, history data, environment data, device information, etc. between functional blocks via APIs, and performs inference and control by AI models in stages. At each step, the AI models perform preprocessing such as normalization, feature extraction, clustering, semantic analysis, and time series pattern extraction on the input data, and automatically select the optimal algorithms and parameters according to the application and situation. Each functional block links the output of the AI models (e.g., category labels, emotion labels, priority scores, recommended method instructions, generated text, UI control parameters, etc.) to subsequent processing, realizing personalization of the user experience, efficiency of information transmission, reduction of cognitive load, and improvement of accessibility. Technical effects include that, unlike conventional uniform information provision, response generation, and UI control, the system combines multi-stage personalization control and real-time adaptation by AI to automatically realize optimal information provision, response generation, and operation experience that respond to user requests and usage environments, greatly improving the flexibility, scalability, and user satisfaction of the entire system. Application fields include instruction manuals for home appliances and furniture, guidance for public facilities, tourist guides, presentation of teaching materials in educational settings, operation instructions for medical devices, maintenance guidance for factory equipment, rehabilitation support, provision of stress care information, and more. Furthermore, the AI models and control algorithms of each functional block can be diversified according to use cases, user attributes, and usage scenes, and the system can flexibly respond to future expansion.

Step 1: The collection unit collects information regarding objects. Information regarding objects includes home appliances, furniture, map bulletin boards, public facilities, and the like. For example, the collection unit collects specifications and usage instructions for home appliances, maintenance information for furniture, location information for map bulletin boards, and usage guidance for public facilities. Step 2: The generation unit generates a prompt based on the information collected by the collection unit. The prompt may be in the form of a question or instruction and serves as input for the generation AI to generate a response. For example, the generation unit generates prompts such as “Tell me how to use this appliance” or “How do I get from XX to XX?” based on the collected information. Step 3: The reading unit reads the information tag. Information tags include QR codes, barcodes, NFC tags, and the like. The reading unit can read information tags using the camera or NFC reader of a smartphone. Step 4: The response generation unit analyzes the prompt read by the reading unit and generates a response. The response may be in the form of text, audio, or image, and is generated by the generation AI based on the prompt. For example, the response generation unit generates responses such as “The way to use this appliance is XX” or “To get from XX to XX, go through XX” using the generation AI. Step 5: The provision unit provides the response generated by the response generation unit to the user. The provision unit can display text or images on the smartphone screen or play the response as audio. Specifically, the system executes data analysis, inference, generation, and control by AI models in stages at each step. For example, the collection unit collects information vectors using web crawlers or IoT device integration APIs; the generation unit generates prompts using category-specialized large language models or rule-based templates; the reading unit acquires tag information using hardware control APIs for the device's camera, NFC, Bluetooth, etc.; the response generation unit generates response text or image data using conditional large language models or image generation AI; and the provision unit provides responses through various output channels (screen display, audio playback, vibration notification, etc.) using user interface control modules or speech synthesis engines. At each step, user attribute vectors, emotion labels, history data, environment data, device information, etc. are used as input to the AI models, and outputs such as category labels, priority scores, recommended method instructions, generated text, and UI control parameters are linked to subsequent processing. Unlike conventional uniform information provision, response generation, and UI control, the system combines multi-stage personalization control and real-time adaptation by AI to automatically realize optimal information provision, response generation, and operation experience that respond to user requests and usage environments, greatly improving the flexibility, scalability, and user satisfaction of the entire system. Technical effects include optimization at each stage of information collection, prompt generation, tag reading, response generation, and response provision; improved personalization of the user experience; improved efficiency of information transmission; reduction of cognitive load; and enhanced accessibility. Application fields include instruction manuals for home appliances and furniture, guidance for public facilities, tourist guides, presentation of teaching materials in educational settings, operation instructions for medical devices, maintenance guidance for factory equipment, rehabilitation support, provision of stress care information, and more. Furthermore, the AI models and control algorithms of each functional block can be diversified according to use cases, user attributes, and usage scenes, and the system can flexibly respond to future expansion.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, generation unit, reading unit, response generation unit, and provision unit is implemented by at least one of, for example, the smart device 14 and the data processing apparatus 12. For example, the collection unit collects information regarding objects using the camera 42 or communication I/F 44 of the smart device 14. The generation unit generates a prompt based on the information collected, for example, by the specific processing unit 290 of the data processing apparatus 12. The reading unit reads the information tag using the camera 42 or NFC reader of the smart device 14. The response generation unit analyzes the prompt and generates a response, for example, by the specific processing unit 290 of the data processing apparatus 12. The provision unit provides the response to the user using the display 40A or speaker 40B of the smart device 14. The correspondence between each unit and the device or control unit is not limited to the above examples and various modifications are possible.

### Second Embodiment

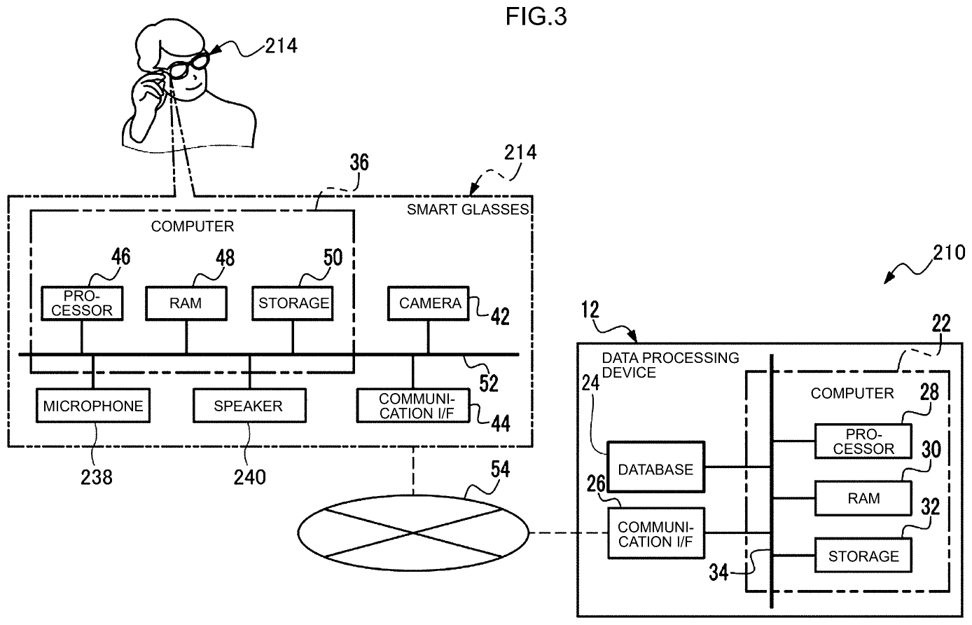

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

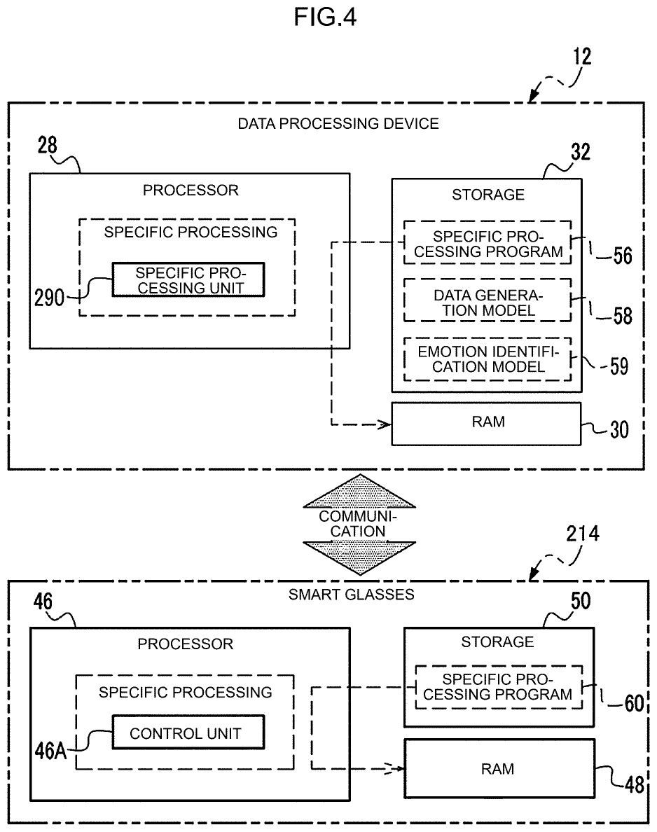

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, generation unit, reading unit, response generation unit, and provision unit is implemented by at least one of, for example, the smart glasses 214 and the data processing apparatus 12. For example, the collection unit collects information regarding objects using the camera 42 or communication I/F 44 of the smart glasses 214. The generation unit generates a prompt based on the information collected, for example, by the specific processing unit 290 of the data processing apparatus 12. The reading unit reads the information tag using the camera 42 or NFC reader of the smart glasses 214. The response generation unit analyzes the prompt and generates a response, for example, by the specific processing unit 290 of the data processing apparatus 12. The provision unit provides the response to the user using the display or speaker of the smart glasses 214. The correspondence between each unit and the device or control unit is not limited to the above examples and various modifications are possible.

### Third Embodiment

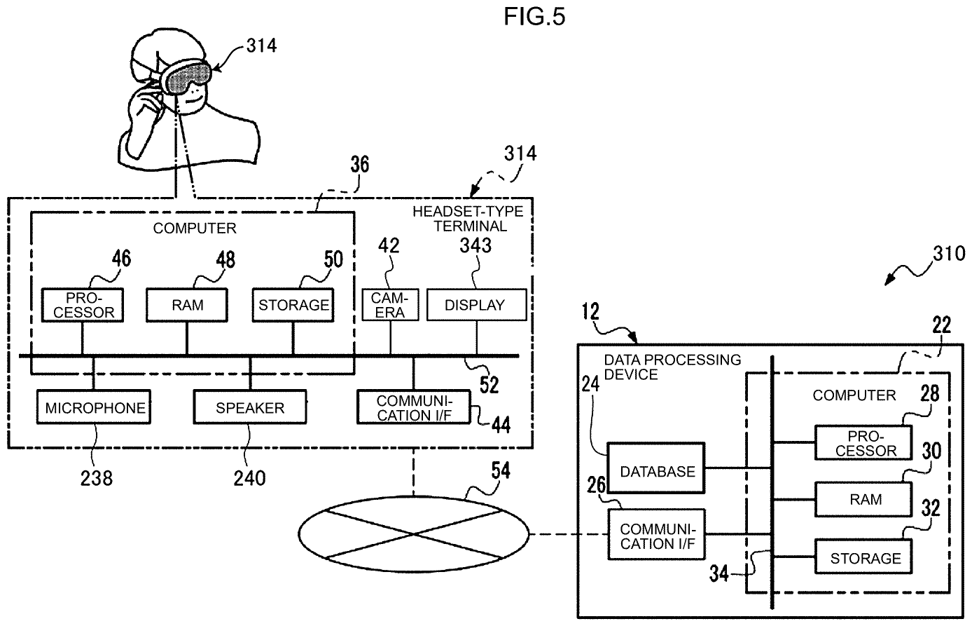

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

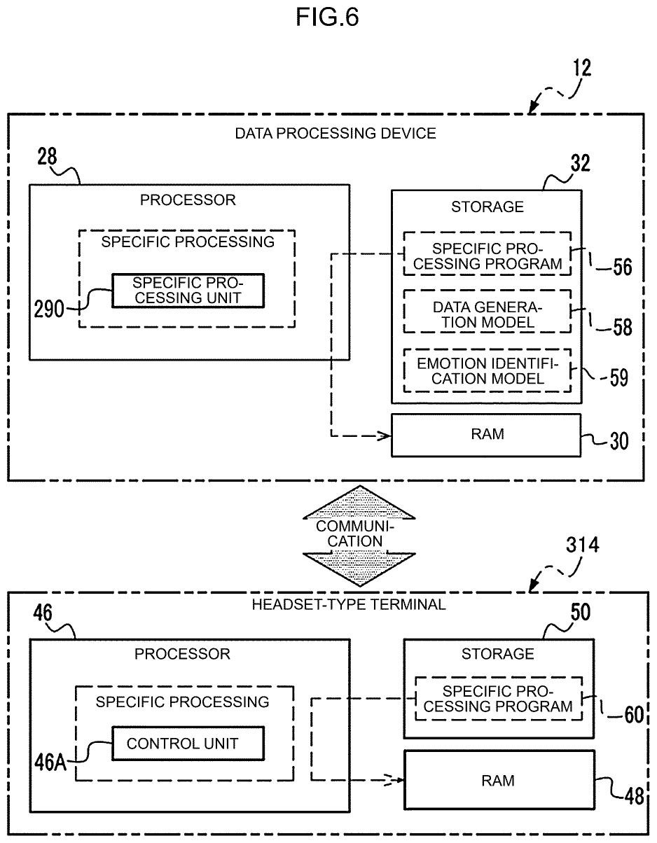

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, generation unit, reading unit, response generation unit, and provision unit is implemented by at least one of, for example, the headset-type terminal 314 and the data processing apparatus 12. For example, the collection unit collects information regarding objects using the camera 42 or communication I/F 44 of the headset-type terminal 314. The generation unit generates a prompt based on the information collected, for example, by the specific processing unit 290 of the data processing apparatus 12. The reading unit reads the information tag using the camera 42 or NFC reader of the headset-type terminal 314. The response generation unit analyzes the prompt and generates a response, for example, by the specific processing unit 290 of the data processing apparatus 12. The provision unit provides the response to the user using the display or speaker of the headset-type terminal 314. The correspondence between each unit and the device or control unit is not limited to the above examples and various modifications are possible.

### Fourth Embodiment

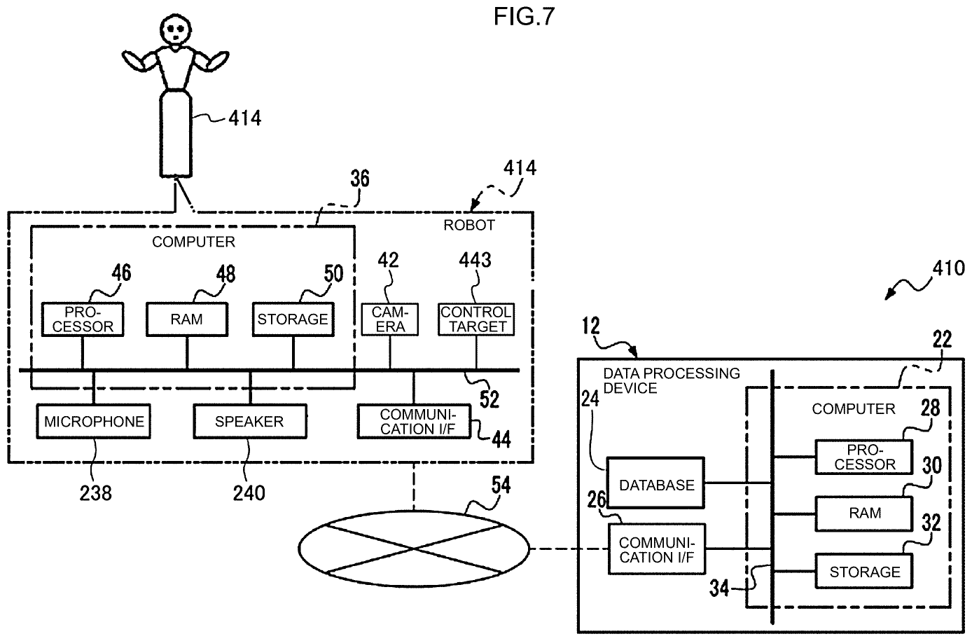

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

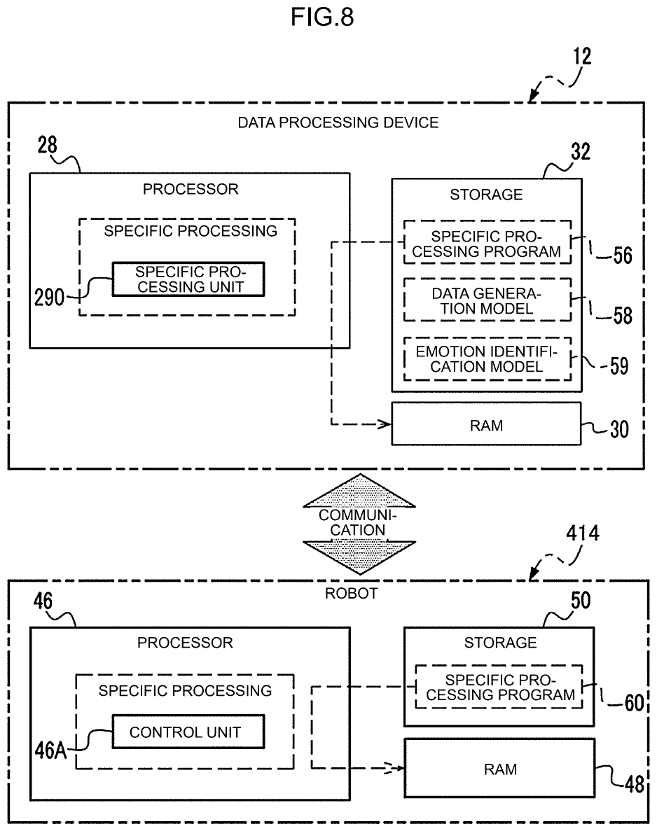

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, generation unit, reading unit, response generation unit, and provision unit is implemented by at least one of, for example, the robot 414 and the data processing apparatus 12. For example, the collection unit collects information regarding objects using the camera 42 or communication I/F 44 of the robot 414. The generation unit generates a prompt based on the information collected, for example, by the specific processing unit 290 of the data processing apparatus 12. The reading unit reads the information tag using the camera 42 or NFC reader of the robot 414. The response generation unit analyzes the prompt and generates a response, for example, by the specific processing unit 290 of the data processing apparatus 12. The provision unit provides the response to the user using the display or speaker of the robot 414. The correspondence between each unit and the device or control unit is not limited to the above examples and various modifications are possible.

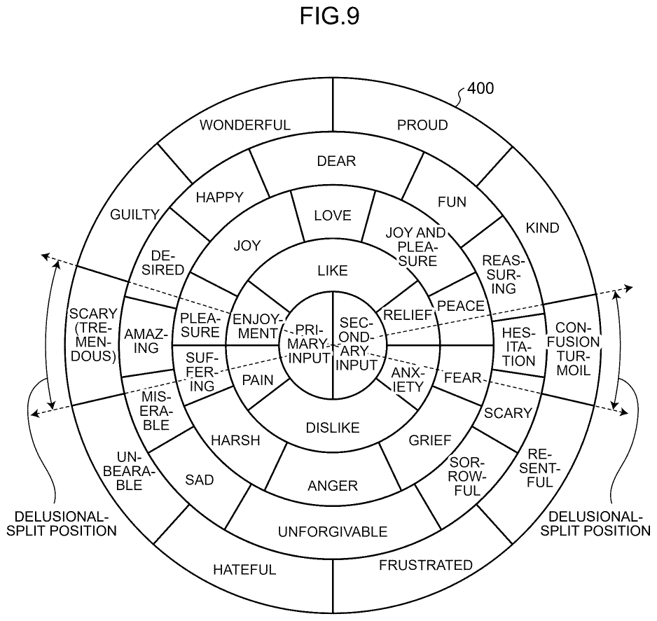

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

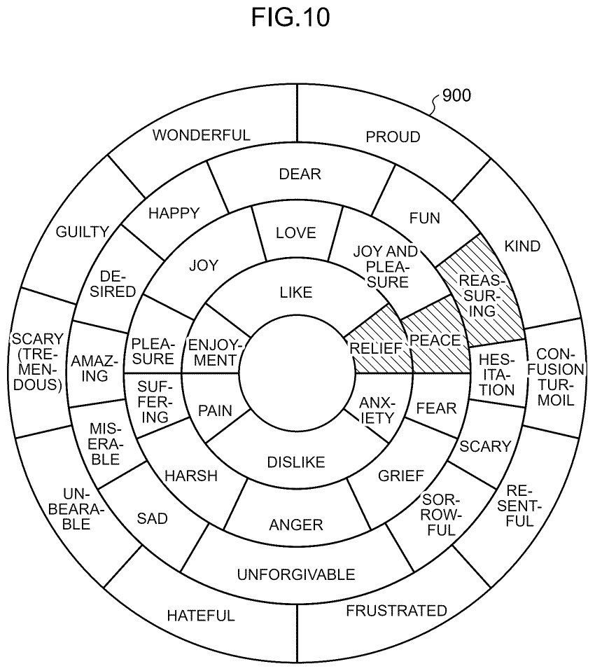

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

### (Supplementary Note 1)

A system comprising: a collection unit configured to collect information regarding objects; a generation unit configured to generate a prompt based on the information collected by the collection unit; a reading unit configured to read an information tag including the prompt generated by the generation unit; a response generation unit configured to analyze the prompt read by the reading unit and generate a response; and a provision unit configured to provide the response generated by the response generation unit to a user.

### (Supplementary Note 2)

The system according to Supplementary Note 1, wherein the collection unit is configured to collect information regarding objects such as home appliances, furniture, map bulletin boards, and public facilities.

### (Supplementary Note 3)

The system according to Supplementary Note 1, wherein the generation unit is configured to generate a prompt based on the collected information.

### (Supplementary Note 4)

The system according to Supplementary Note 1, wherein the reading unit is configured to read the information tag.

### (Supplementary Note 5)

The system according to Supplementary Note 1, wherein the response generation unit is configured to analyze the read prompt and generate a response.

### (Supplementary Note 6)

The system according to Supplementary Note 1, wherein the provision unit is configured to provide the generated response to the user.

### (Supplementary Note 7)

The system according to Supplementary Note 1, wherein the response generation unit is configured to generate a response to a user's question.

### (Supplementary Note 8)

The system according to Supplementary Note 1, wherein the collection unit is configured to estimate the user's emotion and determine the priority of information to be collected based on the estimated emotion of the user.

### (Supplementary Note 9)

The system according to Supplementary Note 1, wherein the collection unit is configured to monitor the frequency and status of use of the object in real time and collect information at an appropriate timing.

### (Supplementary Note 10)

The system according to Supplementary Note 1, wherein the collection unit is configured to detect a change in the state of the object and collect the information thereof.

### (Supplementary Note 11)

The system according to Supplementary Note 1, wherein the collection unit is configured to estimate the user's emotion and adjust the level of detail of information to be collected based on the estimated emotion of the user.

### (Supplementary Note 12)

The system according to Supplementary Note 1, wherein the collection unit is configured to preferentially collect information related to a specific region or environment based on the location information of the object.

### (Supplementary Note 13)

The system according to Supplementary Note 1, wherein the collection unit is configured to collect manufacturer or brand information of the object and improve the reliability of information provided to the user.

### (Supplementary Note 14)

The system according to Supplementary Note 1, wherein the generation unit is configured to estimate the user's emotion and adjust the expression method of the prompt based on the estimated emotion of the user.

### (Supplementary Note 15)

The system according to Supplementary Note 1, wherein the generation unit is configured to adjust the level of detail of the prompt based on the importance of the collected information.

### (Supplementary Note 16)

The system according to Supplementary Note 1, wherein the generation unit is configured to apply different prompt generation algorithms according to the category of the object.

### (Supplementary Note 17)

The system according to Supplementary Note 1, wherein the generation unit is configured to estimate the user's emotion and adjust the length of the prompt based on the estimated emotion of the user.

### (Supplementary Note 18)

The system according to Supplementary Note 1, wherein the generation unit is configured to determine the priority of the prompt based on the submission timing of the collected information.

### (Supplementary Note 19)

The system according to Supplementary Note 1, wherein the generation unit is configured to adjust the order of the prompt based on the relevance of the collected information.

### (Supplementary Note 20)

The system according to Supplementary Note 1, wherein the reading unit is configured to estimate the user's emotion and adjust the method of reading the information tag based on the estimated emotion of the user.

### (Supplementary Note 21)

The system according to Supplementary Note 1, wherein the reading unit is configured to select an appropriate reading method according to the type and performance of the user's device when reading the information tag.

### (Supplementary Note 22)

The system according to Supplementary Note 1, wherein the reading unit is configured to improve reading accuracy according to the surrounding environment when reading the information tag.

### (Supplementary Note 23)

The system according to Supplementary Note 1, wherein the reading unit is configured to estimate the user's emotion and adjust the timing of reading the information tag based on the estimated emotion of the user.

### (Supplementary Note 24)

The system according to Supplementary Note 1, wherein the reading unit is configured to select an optimal reading method by considering the user's location information when reading the information tag.

### (Supplementary Note 25)

The system according to Supplementary Note 1, wherein the reading unit is configured to refer to the user's past reading history and provide an optimal reading method when reading the information tag.

### (Supplementary Note 26)

The system according to Supplementary Note 1, wherein the response generation unit is configured to estimate the user's emotion and adjust the expression method of the response based on the estimated emotion of the user.

### (Supplementary Note 27)

The system according to Supplementary Note 1, wherein the response generation unit is configured to adjust the level of detail of the response based on the importance of the read prompt.

### (Supplementary Note 28)

The system according to Supplementary Note 1, wherein the response generation unit is configured to apply different response generation algorithms according to the category of the read prompt.

### (Supplementary Note 29)

The system according to Supplementary Note 1, wherein the response generation unit is configured to estimate the user's emotion and adjust the length of the response based on the estimated emotion of the user.

### (Supplementary Note 30)

The system according to Supplementary Note 1, wherein the response generation unit is configured to determine the priority of the response based on the submission timing of the read prompt.

### (Supplementary Note 31)

The system according to Supplementary Note 1, wherein the response generation unit is configured to adjust the order of the response based on the relevance of the read prompt.

### (Supplementary Note 32)

The system according to Supplementary Note 1, wherein the provision unit is configured to estimate the user's emotion and adjust the method of providing the response based on the estimated emotion of the user.

### (Supplementary Note 33)

The system according to Supplementary Note 1, wherein the provision unit is configured to select an optimal provision method according to the type and performance of the user's device when providing the response.

### (Supplementary Note 34)

The system according to Supplementary Note 1, wherein the provision unit is configured to refer to the user's past response history and provide an optimal provision method when providing the response.

### (Supplementary Note 35)

The system according to Supplementary Note 1, wherein the provision unit is configured to estimate the user's emotion and adjust the timing of providing the response based on the estimated emotion of the user.

### (Supplementary Note 36)

The system according to Supplementary Note 1, wherein the provision unit is configured to select an optimal provision method by considering the user's location information when providing the response.

### (Supplementary Note 37)

The system according to Supplementary Note 1, wherein the provision unit is configured to analyze the user's social media activity and propose an optimal provision method when providing the response.

What is claimed is:

1. An information processing system comprising:
a communication interface configured to communicate with a client terminal via a packet-switched network;
a storage storing a data generation model obtained by deep learning on a neural network;
a database; and
circuitry configured to:
collect information regarding a physical object by acquiring structured data from a network-accessible source and storing the structured data in the database;
generate a prompt comprising a natural-language instruction for the data generation model based on the collected information;
receive, from the client terminal via the communication interface, tag data obtained by the client terminal reading an information tag affixed to the physical object, the tag data encoding the prompt;
analyze the prompt using the data generation model to generate a response comprising at least one of text data, voice data, or image data; and
transmit the response to the client terminal via the communication interface and the packet-switched network, the response causing the client terminal to output the response to a user.

2. The information processing system according to claim 1,
wherein the information tag comprises at least one of a QR code, a barcode, or an NFC tag.

3. The information processing system according to claim 1,
wherein the data generation model comprises a large-scale language model having one billion to one hundred billion parameters, and
wherein the circuitry is configured to tokenize the prompt, convert the prompt into an embedding vector, and generate the response through encoder-decoder layers of a Transformer architecture.

4. The information processing system according to claim 1,
wherein the circuitry is further configured to assign a confidence score to the response and perform threshold determination based on the confidence score.

5. The information processing system according to claim 1,
wherein the circuitry is further configured to generate the prompt by applying a category-specialized language model selected based on a category of the physical object.

6. The information processing system according to claim 1,
wherein the storage further stores an emotion identification model, and
wherein the circuitry is further configured to estimate an emotion of the user using the emotion identification model and to determine a priority of the information to be collected based on the estimated emotion.

7. The information processing system according to claim 6,
wherein the circuitry is further configured to adjust a level of detail of the collected information based on the estimated emotion, such that when the estimated emotion indicates excitement, detailed information is collected, when the estimated emotion indicates fatigue, concise information is collected, and when the estimated emotion indicates relaxation, comprehensive information is collected.

8. The information processing system according to claim 6,
wherein the circuitry is further configured to adjust an expression style of the prompt based on the estimated emotion.

9. The information processing system according to claim 6,
wherein the circuitry is further configured to adjust an expression style of the response based on the estimated emotion, such that when the estimated emotion indicates relaxation, the response is generated in a friendly expression style, and when the estimated emotion indicates urgency, the response is generated in a concise and clear expression style.

10. The information processing system according to claim 1,
wherein the circuitry is further configured to monitor a frequency of use of the physical object in real time via sensor data received from the client terminal, and to collect the information at a timing determined based on the monitored frequency.

11. The information processing system according to claim 1,
wherein the circuitry is further configured to detect a change in state of the physical object via sensor data and to collect information regarding the change in state.

12. The information processing system according to claim 1,
wherein the circuitry is further configured to collect manufacturer or brand information associated with the physical object and to assign a reliability score to the collected information based on the manufacturer or brand information.

13. The information processing system according to claim 1,
wherein the circuitry is further configured to preferentially collect information related to a specific region or environment based on location information associated with the physical object.

14. The information processing system according to claim 1,
wherein the circuitry is further configured to adjust a level of detail of the prompt based on an importance score assigned to the collected information.

15. The information processing system according to claim 1,
wherein the circuitry is further configured to adjust a level of detail of the response based on an importance score assigned to the prompt.

16. The information processing system according to claim 1,
wherein the circuitry is further configured to apply different response generation algorithms according to a category of the prompt.

17. The information processing system according to claim 1,
wherein the circuitry is further configured to determine a priority of the response based on a submission timing of the prompt, such that a response based on more recently submitted prompt information is transmitted with a higher priority.

18. An information processing system comprising:
a communication interface configured to communicate, via a packet-switched network conforming to at least one of a 5G, Wi-Fi, or Bluetooth communication standard, with a wearable client terminal comprising a camera having a CMOS image sensor, a microphone, a speaker, and a display;
a processor;
a random-access memory;
a storage storing a data generation model obtained by deep learning on a neural network and an emotion identification model;
a database; and
circuitry configured to:
collect information regarding a physical object by acquiring structured data in at least one of JSON or XML format from a network-accessible source and storing the structured data in the database;
generate a prompt comprising a natural-language instruction for the data generation model based on the collected information;
receive, from the wearable client terminal via the communication interface, tag data obtained by the wearable client terminal reading an information tag affixed to the physical object using the camera having the CMOS image sensor, the information tag encoding the prompt;
estimate an emotion of the user using the emotion identification model;
analyze the prompt using the data generation model and generate a response adapted based on the estimated emotion, the response comprising at least one of text data, voice data, or image data; and
transmit the response to the wearable client terminal via the communication interface, the response causing the wearable client terminal to output the response to the user via at least one of the display or the speaker.

19. The information processing system according to claim 18,
wherein the data generation model comprises at least one of a text generation AI, an image generation AI, or a multimodal generation AI, and
wherein the data generation model is a fine-tuned model configured to output inference results from prompts without instructions.

20. A method of processing information, the method being performed by an information processing system comprising a communication interface, a storage storing a data generation model obtained by deep learning on a neural network, and a database, the method comprising:
collecting information regarding a physical object by acquiring structured data from a network-accessible source and storing the structured data in the database;
generating a prompt comprising a natural-language instruction for the data generation model based on the collected information;
receiving, from a client terminal via the communication interface and a packet-switched network, tag data obtained by the client terminal reading an information tag affixed to the physical object, the tag data encoding the prompt;
analyzing the prompt using the data generation model to generate a response comprising at least one of text data, voice data, or image data; and
transmitting the response to the client terminal via the communication interface and the packet-switched network, the response causing the client terminal to output the response to a user.
